(19) United States
(12) Patent Application Publication
(10) Pub. No.: US 2025/0102421 A1
(43) Pub. Date: Mar. 27, 2025

(54) ROAD SURFACE FRICTION ESTIMATION DEVICE

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventor: MITSUYASU ABE, Nisshin-shi (JP)

(21) Appl. No.: 18/777,707

(22) Filed: Jul. 19, 2024

(30) Foreign Application Priority Data
Sep. 27, 2023 (JP) 2023-166382

(51) Int. Cl. G01N 19/02; B60W 40/068

(52) U.S. Cl. CPC G01N 19/02; B60W 40/068

(57) ABSTRACT

A road surface friction estimation device includes: a first estimation part to calculate a provisional maximum friction value based on a physical quantity in relation to friction between a road surface and a tire; a range determination part to determine a determination range of the provisional maximum friction value based on an average value and a standard deviation of the provisional maximum friction values; and a second estimation part to determine the provisional maximum friction value as an estimated maximum friction value when the provisional maximum friction value is within the determination range. The second estimation part determines a corrected value, which is a value within the determination range, as the estimated maximum friction value when the provisional maximum friction value is out of the determination range.

### CROSS REFERENCE TO RELATED APPLICATION

This application is based on Japanese Patent Application No. 2023-166382 filed on Sep. 27, 2023, the disclosure of which is incorporated herein by reference.

### TECHNICAL FIELD

The present disclosure relates to a road surface friction estimation device that estimates a maximum value of a friction coefficient between a road surface and a tire of a vehicle.

### BACKGROUND

A driver assistance system includes a control device that performs vehicle travel control for controlling traveling of a vehicle. The control device of the driver assistance system estimates a maximum value of a friction coefficient between a road surface and a tire of the vehicle, and calculates an upper limit acceleration at which idling of the tire does not occur on the basis of the estimated maximum value of the friction coefficient.

### SUMMARY

According to an aspect of the present disclosure, a road surface friction estimation device estimates a maximum value of a friction coefficient between a road surface on which a vehicle travels and a tire of the vehicle, and obtains the estimated maximum value of the friction coefficient as an estimated maximum friction value. The road surface friction estimation device includes: a first estimation part that repeatedly calculates a provisional maximum friction value that is a provisional value of the estimated maximum friction value on the basis of a physical quantity detected during traveling of the vehicle in relation to friction between the road surface and the tire; a range determination part that determines, based on an average value and a standard deviation of the provisional maximum friction values obtained from the provisional maximum friction values calculated by the first estimation part, a determination range of the provisional maximum friction value including the average value; and a second estimation part that determines the provisional maximum friction value as the estimated maximum friction value when the provisional maximum friction value is within the determination range, and determines a corrected value, which is a value within the determination range, as the estimated maximum friction value when the provisional maximum friction value is out of the determination range.

### BRIEF DESCRIPTION OF DRAWINGS

FIG. 1 is a view schematically illustrating a vehicle on which a road surface friction estimation device is mounted in a first embodiment.

FIG. 2 is a block diagram illustrating a functional configuration of the road surface friction estimation device in the first embodiment.

FIG. 3 is a flowchart illustrating control processing to be executed by the road surface friction estimation device in the first embodiment.

FIG. 4 is a flowchart illustrating a subroutine to be executed in a step S103 in FIG. 3.

FIG. 5 is a friction coefficient map used to calculate a provisional maximum friction value in a step S101 in FIG. 3.

FIG. 6 is a block diagram illustrating a functional configuration of a range determination part in FIG. 2 in the first embodiment.

FIG. 7A is a time chart schematically illustrating provisional maximum friction values calculated at a predetermined calculation cycle in the first embodiment.

FIG. 7B is a view schematically illustrating an appearance frequency distribution of the repeatedly calculated provisional maximum friction values.

FIG. 8 is a view schematically illustrating a process content of a step S105 in FIG. 3 using a time chart of estimated maximum friction values in the first embodiment.

FIG. 9 is a view schematically illustrating a process content of a step S106 in FIG. 3 using the time chart of the estimated maximum friction values in the first embodiment.

FIG. 10 is time charts for explaining the control processing in FIGS. 3 and 4 in the first embodiment.

FIG. 11 is a flowchart illustrating control processing to be executed by a road surface friction estimation device in a second embodiment, corresponding to FIG. 3.

FIG. 12 is a flowchart illustrating a subroutine to be executed in a step S111 in FIG. 11 in the second embodiment, corresponding to FIG. 4.

FIG. 13 is a block diagram illustrating a functional configuration of the range determination part in FIG. 2 in the second embodiment, corresponding to FIG. 6.

FIG. 14 is a time chart for explaining an average value of provisional maximum friction values sequentially updated in the control processing in FIGS. 11 and 12 of the second embodiment.

FIG. 15 is a flowchart illustrating a subroutine to be executed in the step S111 in FIG. 11 in a third embodiment, corresponding to FIG. 4.

FIG. 16 is a time chart for explaining an average value of provisional maximum friction values sequentially updated in control processing in FIGS. 11 and 15 of the third embodiment.

FIG. 17 is time charts for explaining the control processing in FIGS. 11 and 15 in the third embodiment, corresponding to FIG. 10.

FIG. 18 is a flowchart illustrating control processing to be executed by a road surface friction estimation device in a fourth embodiment, corresponding to FIG. 3.

FIG. 19 is time charts for explaining the control processing in FIGS. 15 and 18 in the fourth embodiment, corresponding to FIG. 10.

FIG. 20 is a block diagram illustrating a functional configuration of a road surface friction estimation device in a fifth embodiment, corresponding to FIG. 2.

FIG. 21 is a flowchart illustrating control processing to be executed by the road surface friction estimation device in the fifth embodiment, corresponding to FIG. 3.

FIG. 22 is a flowchart illustrating a subroutine to be executed in a step S111 in FIG. 21 in the fifth embodiment, corresponding to FIG. 12.

FIG. 23 is time charts for explaining control processing in FIGS. 21 and 22 in the fifth embodiment, corresponding to FIG. 10.

FIG. 24 is a block diagram illustrating a functional configuration of a road surface friction estimation device in a sixth embodiment, corresponding to FIG. 2.

FIG. 25 is time charts for explaining a problem that can occur in a comparative example contrasted with the sixth embodiment.

FIG. 26 is time charts for explaining that the problem that can occur in the comparative example is solved in the sixth embodiment, corresponding to FIG. 25.

FIG. 27 is a flowchart illustrating control processing to be executed by the road surface friction estimation device in the sixth embodiment, corresponding to FIG. 11.

FIG. 28 is a flowchart illustrating a subroutine to be executed in a step S111 in FIG. 27 in the sixth embodiment, corresponding to FIG. 15.

FIG. 29 is a block diagram schematically illustrating a functional configuration of a road surface determination part in the sixth embodiment.

FIG. 30 is time charts for explaining control processing to be executed in the comparative example contrasted with the sixth embodiment, corresponding to FIG. 17.

FIG. 31 is time charts for explaining the control processing in FIGS. 27 and 28 in the sixth embodiment, corresponding to FIG. 30.

### DESCRIPTION OF EMBODIMENTS

A driver assistance system includes a control device that performs vehicle travel control for controlling traveling of a vehicle. The control device of the driver assistance system estimates a maximum value of a friction coefficient between a road surface and a tire of the vehicle, and calculates an upper limit acceleration at which idling of the tire does not occur on the basis of the estimated maximum value of the friction coefficient.

In the driver assistance system, the maximum value of the friction coefficient is estimated, and the estimated maximum friction value, which is the maximum value of the estimated friction coefficient, is calculated on the basis of various physical quantities obtained during traveling of the vehicle. Since the physical quantities, on which the estimated maximum friction value is based, are affected by disturbance, the estimated maximum friction value obtained by the driver assistance system is calculated under the influence of disturbance.

However, if the estimated maximum friction value is calculated under the influence of aperiodic disturbance, the variation in the estimated maximum friction value becomes excessively large when the estimated maximum friction value is used for vehicle traveling control or the like. As a result of detailed studies by the inventors, the above has been found. Examples of the aperiodic disturbance include a case where a tire of a vehicle runs on a pebble and a case where a tire of a vehicle falls into a depression of a road surface.

The present disclosure provides a road surface friction estimation device to obtain an estimated maximum friction value while suppressing influence of aperiodic disturbance.

According to an aspect of the present disclosure, a road surface friction estimation device estimates a maximum value of a friction coefficient between a road surface on which a vehicle travels and a tire of the vehicle, and obtains the estimated maximum value of the friction coefficient as an estimated maximum friction value. The road surface friction estimation device includes: a first estimation part that repeatedly calculates a provisional maximum friction value that is a provisional value of the estimated maximum friction value on the basis of a physical quantity detected during traveling of the vehicle in relation to friction between the road surface and the tire; a range determination part that determines, based on an average value and a standard deviation of the provisional maximum friction values obtained from a plurality of the provisional maximum friction values calculated by the first estimation part, a determination range of the provisional maximum friction value including the average value; and a second estimation part that determines the provisional maximum friction value as the estimated maximum friction value when the provisional maximum friction value is within the determination range, and determines a corrected value, which is a value within the determination range, as the estimated maximum friction value when the provisional maximum friction value is out of the determination range.

With this way, if a provisional maximum friction value varies aperiodically, a second estimation part determines the corrected value, from which the aperiodic variation is removed, as the estimated maximum friction value. Therefore, the estimated maximum friction value can be obtained while the influence of the aperiodic disturbance is suppressed.

According to another aspect of the present disclosure, a road surface friction estimation device estimates a maximum value of a friction coefficient between a road surface on which a vehicle travels and a tire of the vehicle, and obtains the estimated maximum value of the friction coefficient as an estimated maximum friction value. The road surface friction estimation device includes: a first estimation part that repeatedly calculates a provisional maximum friction value that is a provisional value of the estimated maximum friction value on the basis of a physical quantity detected during traveling of the vehicle in relation to friction between the road surface and the tire; a range determination part that determines, based on an average value and a standard deviation of the provisional maximum friction values obtained from a plurality of the provisional maximum friction values calculated by the first estimation part, a determination range of the provisional maximum friction value including the average value; and a second estimation part that determines the provisional maximum friction value as the estimated maximum friction value when the provisional maximum friction value is within the determination range, and determines a median of the plurality of the provisional maximum friction values, which have been the basis for the average value, as the estimated maximum friction value when the provisional maximum friction value is out of the determination range.

With this way, if a provisional maximum friction value varies aperiodically, the second estimation part determines the median, at which the influence of the aperiodic variation in the provisional maximum friction value is diluted, as the estimated maximum friction value. Therefore, the estimated maximum friction value can be obtained while the influence of the aperiodic disturbance is suppressed.

Hereinafter, embodiments will be described with reference to the drawings. In the respective embodiments below, portions the same or equivalent as or to each other will be denoted by the same reference numerals in the drawings.

### First Embodiment

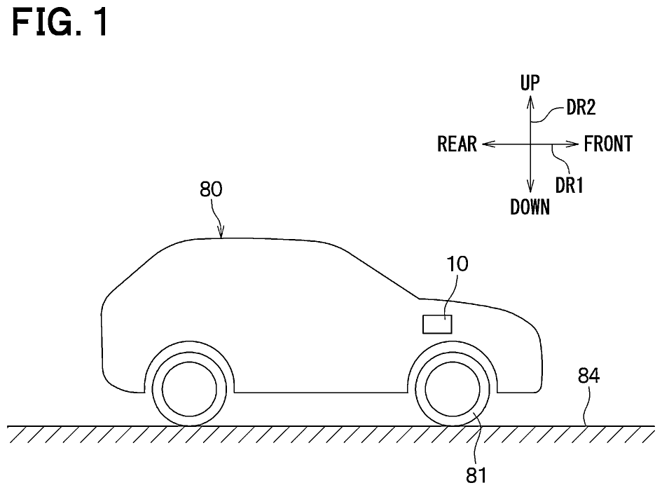

As illustrated in FIG. 1, a road surface friction estimation device 10 of the present embodiment is mounted on a vehicle 80 that is, for example, an electric vehicle, and is used in a vehicle control system that controls traveling of the vehicle 80. The double-ended arrows in FIG. 1 respectively indicate directions of the vehicle 80 on which the road surface friction estimation device 10 is mounted. That is, in FIG. 1, a vehicle front-rear direction DR1, which is the front-rear direction of the vehicle 80, and a vehicle up-down direction DR2, which is the up-down direction of the vehicle 80, are indicated by the double-ended arrows, respectively.

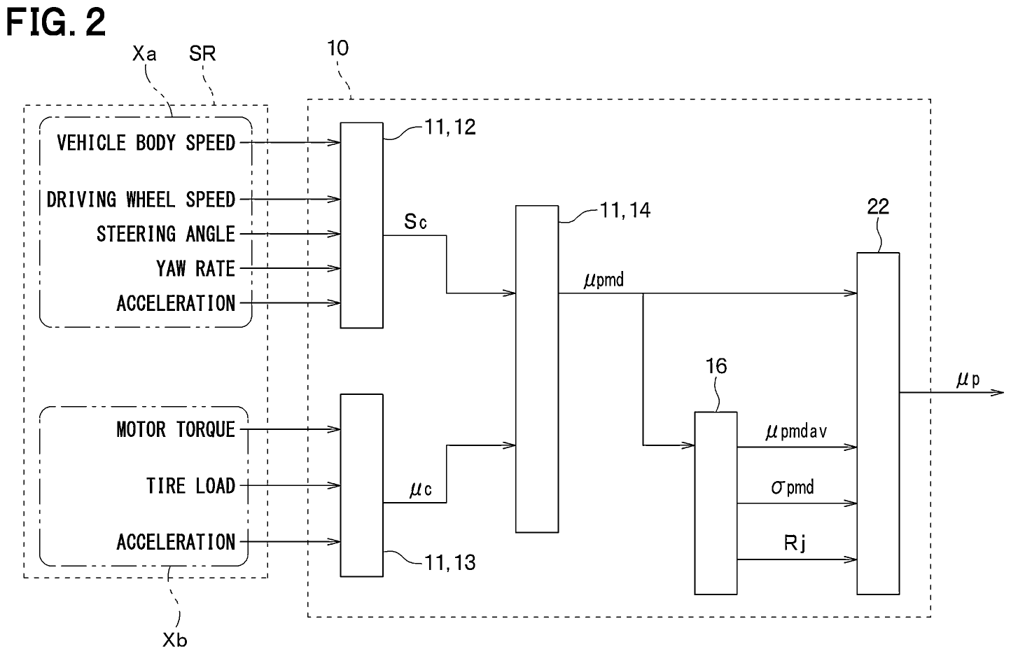

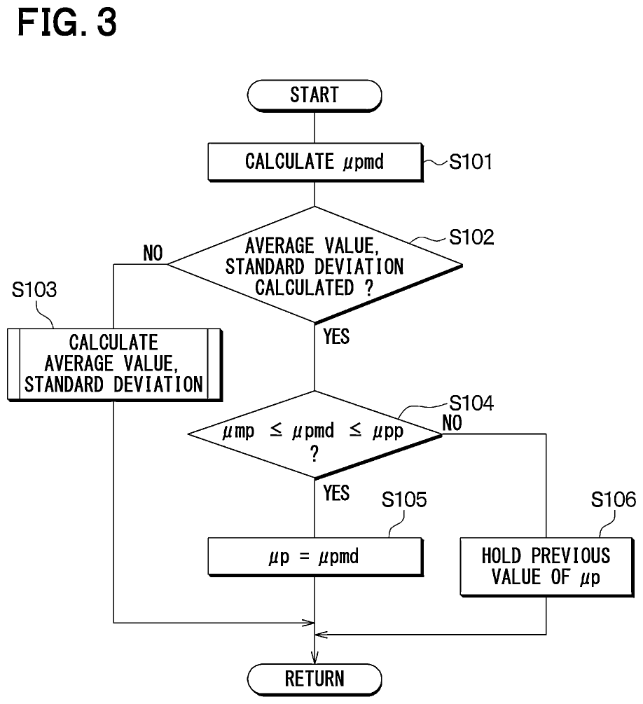

As illustrated in FIG. 2, the road surface friction estimation device 10 is an electronic control device having a configuration as an in-vehicle microcomputer including a CPU, a RAM, a ROM, a non-volatile rewritable memory, and the like. That is, the road surface friction estimation device 10 reads and executes a computer program stored in the ROM or the non-volatile rewritable memory that is a non-transitory tangible storage medium. When this computer program is executed, a method corresponding to the computer program is executed. For example, the road surface friction estimation device 10 executes various control processing, such as control processing in FIG. 3 to be described later, according to the computer program.

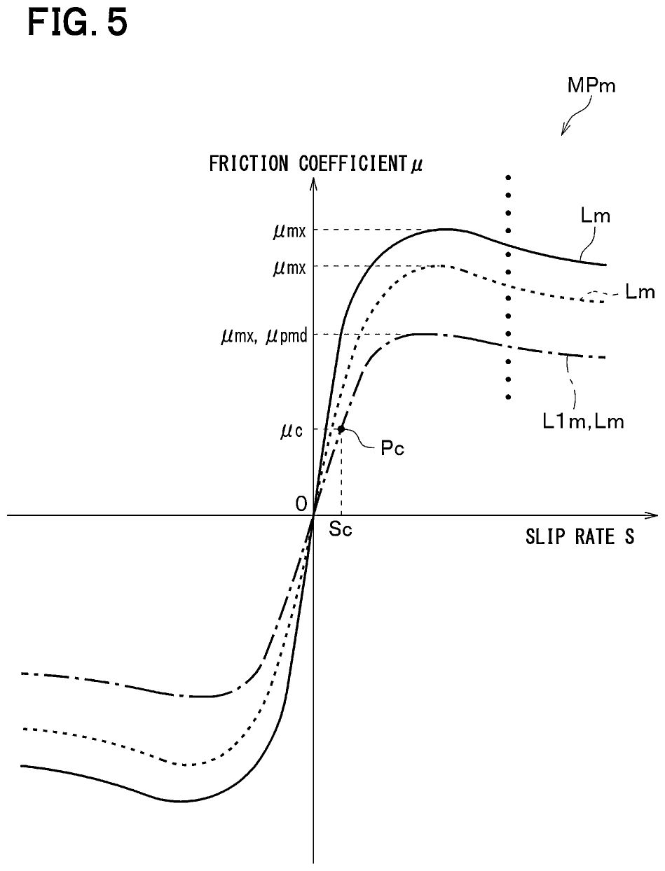

As illustrated in FIGS. 1 and 2, the road surface friction estimation device 10 estimates a maximum value μmx (see FIG. 5 to be described later) of a friction coefficient μ between a road surface 84 on which the vehicle 80 travels and a tire 81 that is a driving wheel of the vehicle 80, and obtains the estimated maximum value μmx of the friction coefficient μ as an estimated maximum friction value up. For this purpose, the road surface friction estimation device 10 includes a first estimation part 11, a range determination part 16, and a second estimation part 22. The first estimation part 11 includes a slip calculation part 12, a friction calculation part 13, and a provisional value calculation part 14.

In addition, the road surface friction estimation device 10 is electrically connected to a detection part SR including sensors, and can learn various physical quantities detected by the detection part SR. The vehicle 80 has plural driving wheels, but in the present embodiment, the estimated maximum friction value up is calculated for each wheel of the tire 81 that is a driving wheel by the road surface friction estimation device 10.

The detection part SR is a sensor group that detects, among the information related to the behavior of the vehicle 80, various types of information related to friction between the road surface 84 and the tire 81 when the vehicle 80 travels on the road surface 84, and is provided in the vehicle 80. Specifically, the detection part SR includes a vehicle speed sensor that detects a vehicle body speed that is a speed of the vehicle 80, a wheel speed sensor that detects a driving wheel speed that is a rotational speed of the tire 81, and a steering angle sensor that detects a steering angle that is a rotational angle of the steering wheel. The detection part SR also includes a yaw rate sensor that detects a yaw rate that is a rotational angular velocity in the yaw direction of the vehicle 80, and an acceleration sensor that detects an acceleration of the vehicle 80. The detection part SR further includes a torque sensor that detects motor torque that is output torque of the traveling motor, and a load sensor that detects a tire load that is a load in the vertical direction generated in the tire 81. The detection part SR transmits detection signals corresponding to detection values detected by these various sensors to the road surface friction estimation device 10.

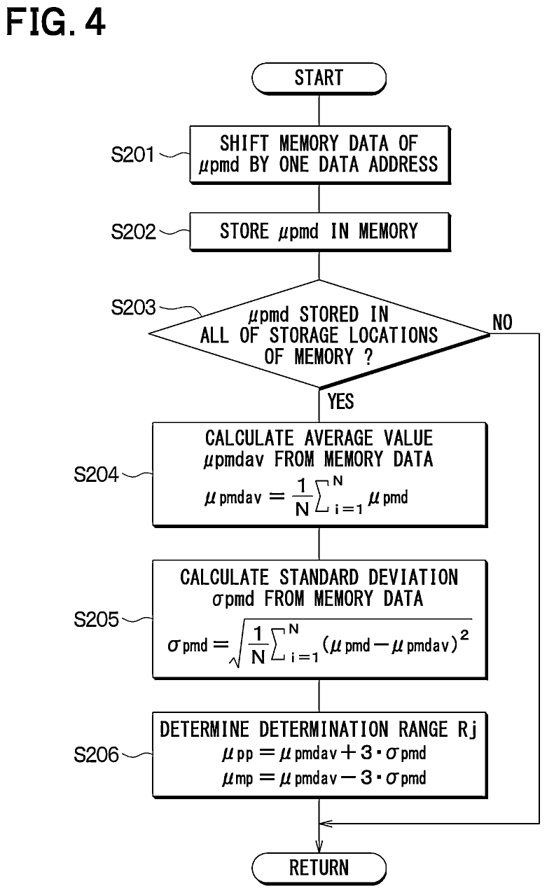

The road surface friction estimation device 10 repeatedly executes the control processing in FIG. 3 at a predetermined calculation cycle Tc while the vehicle is traveling, thereby sequentially calculating the estimated maximum friction value up. FIG. 3 is a flowchart illustrating the control processing to be executed by the road surface friction estimation device 10. FIG. 4 is a flowchart illustrating a subroutine to be executed in a step S103 in FIG. 3.

In a step S101 in FIG. 3, the slip calculation part 12 and the friction calculation part 13 first learn related physical quantities Xa and Xb, which are physical quantities related to the friction between the road surface 84 and the tire 81 and detected while the vehicle 80 is traveling, from the various sensors of the detection part SR, respectively. Then, the slip calculation part 12 calculates a slip rate S between the tire 81 and the road surface 84 on the basis of the related physical quantities Xa, and the friction calculation part 13 calculates the friction coefficient μ between the tire 81 and the road surface 84 on the basis of the related physical quantities Xb. The slip rate S calculated by the slip calculation part 12 is referred to as a calculated slip rate Sc, and the friction coefficient μ calculated by the friction calculation part 13 is referred to as a calculated friction coefficient uc. The slip rate S is a degree of slipping of the rotating tire 81 with respect to the road surface 84.

Specifically, the related physical quantities Xa learned by the slip calculation part 12 are the vehicle body speed, the driving wheel speed, the steering angle, the yaw rate of the vehicle 80, and the acceleration of the vehicle 80. The related physical quantities Xb learned by the friction calculation part 13 are the motor torque, the tire load, and the acceleration of the vehicle 80.

In the present embodiment, the calculated slip rate Sc and the calculated friction coefficient μc are calculated also in consideration of skidding of the vehicle 80. Therefore, the related physical quantities Xa learned by the slip calculation part 12 include the steering angle, the yaw rate of the vehicle 80, and the acceleration of the vehicle 80, and the related physical quantities Xb learned by the friction calculation part 13 include the acceleration of the vehicle 80. For example, the motor torque obtained from the detection part SR is converted into the driving wheel torque applied to one tire 81 and then used for calculating the calculated friction coefficient μc.

In the step S101, when the calculated slip rate Sc and the calculated friction coefficient μc are calculated, the provisional value calculation part 14 calculates a provisional maximum friction value upmd, which is a provisional value of the estimated maximum friction value μp, on the basis of the calculated slip rate Sc and the calculated friction coefficient μc.

Although various calculation methods of the provisional maximum friction value μpmd are assumed, the provisional value calculation part 14 of the present embodiment calculates the provisional maximum friction value μpmd using a friction coefficient map MPm in FIG. 5. The friction coefficient map MPm in FIG. 5 is a map obtained by experimentally measuring in advance the relationship between the slip rate S and the friction coefficient μ in various road surface conditions. The friction coefficient map MPm is represented by a coordinate system with the slip rate S and the friction coefficient μ as coordinate axes, and includes a large number of relationship curves Lm indicating the relationship between the slip rate S and the friction coefficient μ. The respective large number of relationship curves Lm are obtained from road surface conditions different from each other, and indicate the maximum values μmx of the friction coefficients μ different from each other.

For example, when the calculated slip rate Sc and the calculated friction coefficient μc are calculated, the provisional value calculation part 14 specifies a relation point Pc indicating the calculated slip rate Sc and the calculated friction coefficient μc in the friction coefficient map MPm. Then, the provisional value calculation part 14 specifies which one of the large number of relationship curves Lm the relationship point Pc is located on, and calculates the maximum value μmx of the friction coefficient μ indicated by the relationship curve Lm, on which the relationship point Pc is located, as the provisional maximum friction value μpmd.

When the relationship point Pc indicating the calculated slip rate Sc and the calculated friction coefficient μc is located on a relationship curve L1m of the large number of relationship curves Lm as illustrated, for example, in FIG. 5, the maximum value μmx of the friction coefficient μ indicated by the relationship curve L1m is calculated as the provisional maximum friction value μpmd. After the step S101 in FIG. 3, the processing proceeds to a step S102.

In the step S102, the range determination part 16 determines whether an average value μpmdav and a standard deviation σpmd of the provisional maximum friction values μpmd have already been calculated in steps S204 and S205 in FIG. 4 to be described later. In short, the range determination part 16 determines whether the average value μpmdav and the standard deviation σpmd have been calculated.

For example, when the steps S204 and S205 have not been executed yet since the start of the flowchart in FIG. 3, the range determination part 16 determines that the average value μpmdav and the standard deviation σpmd of the provisional maximum friction values μpmd have not been calculated. On the other hand, when the steps S204 and S205 have already been executed since the start of this flowchart, the range determination part 16 determines that the average value μpmdav and the standard deviation σpmd of the provisional maximum friction values μpmd have already been calculated.

When it is determined in the step S102 that the average value μpmdav and the standard deviation σpmd of the provisional maximum friction values μpmd have not been calculated, the processing proceeds to the step S103. On the other hand, when it is determined that the average value μpmdav and the standard deviation σpmd of the provisional maximum friction values μpmd have already been calculated, the processing proceeds to a step S104.

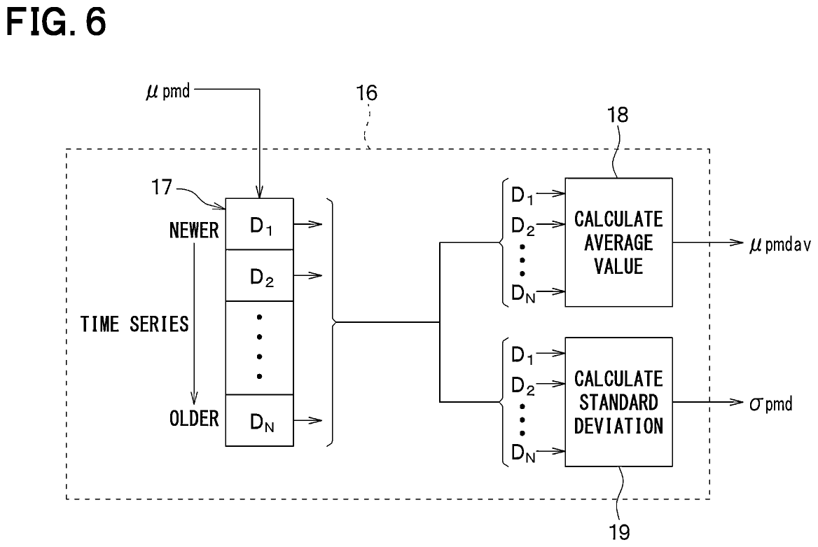

In the step S103, the range determination part 16 executes the subroutine in FIG. 4. As illustrated in FIG. 6, the range determination part 16 includes a storage device 17 that is a memory used in the subroutine in FIG. 4. The storage device 17 includes, for example, a flash memory or a RAM, and functions as a data storage part that sequentially stores the provisional maximum friction value μpmd every time the provisional value calculation part 14 calculates the provisional maximum friction value μpmd in the step S101.

When the subroutine in FIG. 4 is executed in the step S103 and the subroutine ends and the processing returns to the flowchart in FIG. 3, the flowchart in FIG. 3 ends. Then, the flowchart in FIG. 3 starts again from the step S101.

In a step S201 in FIG. 4, the range determination part 16 shifts memory data, which are the provisional maximum friction values μpmd already stored in the storage device 17, to the older memory data side by one data address.

Here, the storage device 17 in FIG. 6 will be described. The storage device 17 is configured to store N provisional maximum friction values μpmd as the memory data, and a data address is allocated to a storage location for each memory data. That is, the number of the storage locations for the memory data in the storage device 17 is N.

The provisional maximum friction values μpmd are sequentially stored in the storage device 17 in time series. Specifically, D₁, D₂, . . . , and D_{N} in FIG. 6 each represent memory data that are the stored provisional maximum friction values μpmd. Subscripts “1, 2, . . . , and N” of D represent the data addresses, and it is meant that a smaller value of the subscript, the newer the stored provisional maximum friction value μpmd.

Since the storage device 17 is configured as described above, for example, memory data D_{N-1} becomes memory data D_{N}, memory data D₂ becomes memory data D₃, and memory data D₁ becomes memory data D₂, when the step S201 in FIG. 4 is executed. Then, the storage location for the memory data Di becomes empty. In the initial state of the storage device 17, the provisional maximum friction values μpmd are not stored at all. When the storage device 17 is in the initial state, it is meaningless to shift the memory data, and thus the range determination part 16 does nothing in the step S201. After the step S201 in FIG. 4, the processing proceeds to a step S202.

In the step S202, the range determination part 16 stores the provisional maximum friction value μpmd calculated in the step S101 in FIG. 3 in the storage device 17. In detail, the provisional maximum friction value μpmd calculated in the step S101 is stored in the storage location for the latest provisional maximum friction value μpmd among the storage locations of the storage device 17. That is, the provisional maximum friction value μpmd calculated in the step S101 is stored in the storage device 17 as the memory data D₁. After the step S202 in FIG. 4, the processing proceeds to a step S203.

In the step S203, the range determination part 16 determines whether the provisional maximum friction values μpmd are stored in all of the storage locations of the storage device 17. In other words, since the number of the storage locations included in the storage device 17 is N as illustrated in FIG. 6, the range determination part 16 determines whether N provisional maximum friction values μpmd have been stored in the storage device 17.

When it is determined in the step S203 that the provisional maximum friction values μpmd have been stored in all of the storage locations of the storage device 17, the processing proceeds to the step S204. On the other hand, when it is determined that the provisional maximum friction values μpmd are not stored in all of the storage locations of the storage device 17 and there is still an empty location in the storage locations of the storage device 17, the subroutine in FIG. 4 ends and the processing returns to the flowchart in FIG. 3.

As illustrated in FIG. 6, the range determination part 16 includes an average value calculation part 18 and a standard deviation calculation part 19 in addition to the storage device 17 described above. In the step S204 in FIG. 4, the average value calculation part 18 calculates the average value μpmdav of the provisional maximum friction values μpmd from a following formula F1 on the basis of the memory data D₁ to D_{N} that are the provisional maximum friction values μpmd stored in the storage device 17. In short, the average value calculation part 18 calculates the average value μpmdav of the memory data D₁ to D_{N} stored in the storage device 17.

$$μ pmdav = \frac{1}{N} {\sum }_{i = 1}^{N} μ pmd \qquad ( F1 )$$

In the subsequent step S205, the standard deviation calculation part 19 calculates the standard deviation σpmd of the provisional maximum friction values μpmd from a following formula F2 on the basis of the memory data D₁ to D_{N} that are the provisional maximum friction values μpmd stored in the storage device 17 and the average value μpmdav calculated from the above formula F1. In short, the standard deviation calculation part 19 calculates the standard deviation σpmd of the memory data D₁ to D_{N} stored in the storage device 17.

$$σ pmd = \sqrt{\frac{1}{N} {\sum }_{i = 1}^{N} {( μ pmd - μ pmdav )}^{2}} \qquad ( F2 )$$

A variable i in the above formulas F1 and F2 indicates a data address of the storage device 17. That is, the variable i indicates the subscript “1, 2, . . . , or N” of the memory data D in FIG. 6. Therefore, the provisional maximum friction value μpmd in the above formulas F1 and F2 is defined as the provisional maximum friction value μpmd stored in the storage device 17 as the memory data Di. The same is also true for the later-described calculation formula corresponding to the above formula F1 or F2, for example, for the later-described formula F9 or F10. After the step S205 in FIG. 4, the processing proceeds to a step S206.

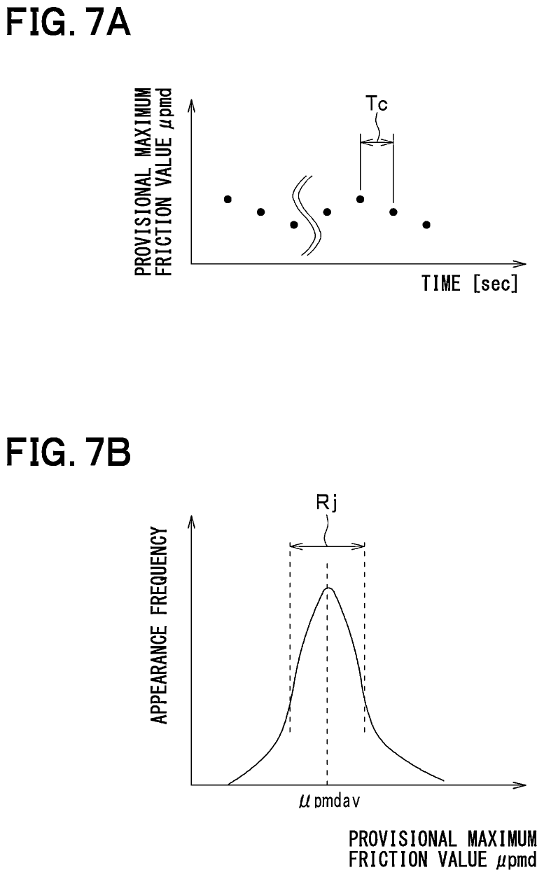

In the step S206, the range determination part 16 determines a determination range Rj of the provisional maximum friction value μpmd on the basis of the average value μpmdav of the provisional maximum friction values μpmd calculated in the step S204 and the standard deviation σpmd of the provisional maximum friction values μpmd calculated in the step S205. This determination range Rj is used as illustrated in FIG. 7B for the provisional maximum friction value μpmd that varies as illustrated in FIG. 7A due to periodic disturbance and aperiodic disturbance. The determination range Rj is formed as a range including the average value μpmdav in the determination range Rj.

In the present embodiment, the determination range Rj is defined, for example, as a range of “μpmdav±3·σpmd”. Therefore, in the step S206, the range determination part 16 calculates an upper limit value μpp of the determination range Rj from a following formula F3, and calculates a lower limit value ump of the determination range Rj from a following formula F4.

$$μ pp = μ pmdav + 3 \cdot σ pmd \qquad ( F3 )$$

$$μ mp = μ pmdav - 3 \cdot σ pmd \qquad ( F4 )$$

When the step S206 ends, the subroutine in FIG. 4 ends and the processing returns to the flowchart in FIG. 3.

Returning to FIG. 3, the second estimation part 22 determines in the step S104 whether the provisional maximum friction value μpmd calculated in the step S101 is within the determination range Rj. In other words, the second estimation part 22 determines whether a following inequality F5 is satisfied. When the following inequality F5 is satisfied, the second estimation part 22 determines that the provisional maximum friction value μpmd is within the determination range Rj. On the other hand, when the following inequality F5 is not satisfied, the second estimation part 22 determines that the provisional maximum friction value μpmd is out of the determination range Rj.

$$μ mp \leq μ pmd \leq μ pp \qquad ( F5 )$$

When it is determined, in the step S104, that the provisional maximum friction value μpmd is within the determination range Rj, the processing proceeds to the step S105. On the other hand, when it is determined that the provisional maximum friction value μpmd is out of the determination range Rj, the processing proceeds to a step S106.

The range of fluctuation of the provisional maximum friction value μpmd is separated in such a way that, for example, as a way of thinking, the inside of the determination range Rj is defined as a range of fluctuation, due to periodic disturbance, of the provisional maximum friction value μpmd, and the outside of the determination range Rj is defined as a range of fluctuation, due to aperiodic disturbance, of the provisional maximum friction value μpmd.

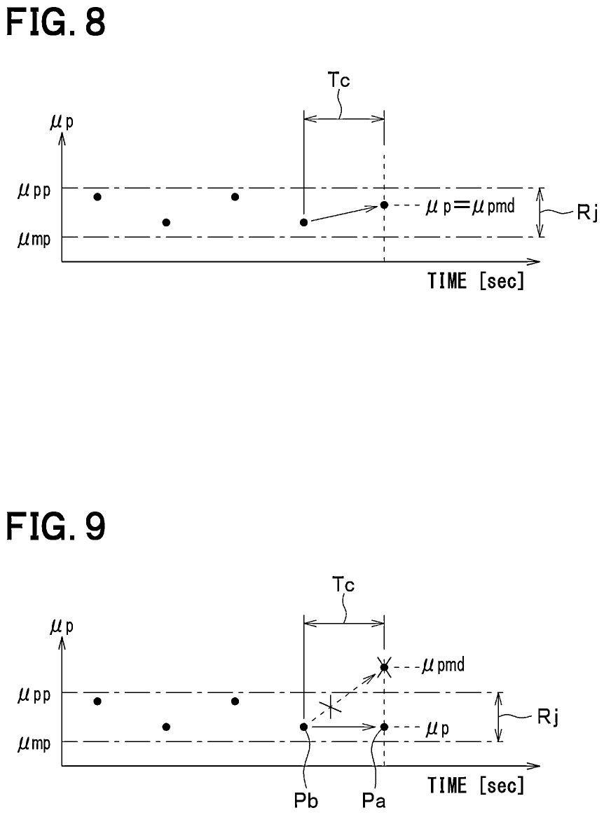

In the step S105, the second estimation part 22 determines the provisional maximum friction value μpmd as the estimated maximum friction value μp. In the step S105, the provisional maximum friction value μpmd is within the determination range Rj as illustrated, for example, in FIG. 8, and thus the estimated maximum friction value μp is defined as being the same value as the provisional maximum friction value μpmd.

In the step S106, the second estimation part 22 determines a corrected value, which is a value within the determination range Rj, as the estimated maximum friction value μp. In the present embodiment, the corrected value is defined as the previous value of the estimated maximum friction value μp repeatedly determined as the flowchart in FIG. 3 is repeatedly executed.

In the step S106, the provisional maximum friction value μpmd is out of the determination range Rj as illustrated, for example, in FIG. 9, and thus the provisional maximum friction value μpmd is not adopted. Then, the estimated maximum friction value μp determined in the current step S106, in other words, the current value of the estimated maximum friction value μp indicated by a point Pa in FIG. 9, is defined as being the same value as the previous value of the estimated maximum friction value μp indicated by a point Pb.

When the step S105 or the step S106 ends, the flowchart in FIG. 3 ends. Then, the flowchart in FIG. 3 starts again from the step S101. As the flowchart in FIG. 3 is repeatedly executed in this manner, the second estimation part 22 repeatedly determines the estimated maximum friction value μp in the step S105 or the step S106 every time the provisional maximum friction value μpmd is calculated in the step S101.

In addition, the second estimation part 22 outputs the estimated maximum friction value μp determined in the step S105 or the step S106 to external control equipment. Examples of the external control equipment include a control device for traction control and an ABS control device. The ABS stands for Anti-lock Brake System.

The process of each step in FIGS. 3 and 4 described above constitutes a functional part that implements each function. The same is also true for the later-described flowchart.

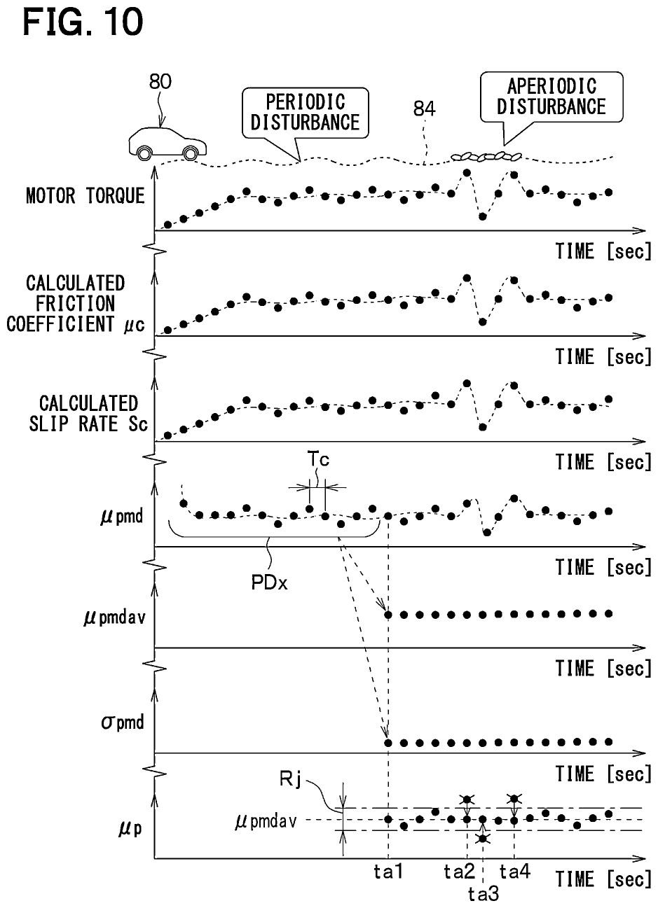

Next, the control processing in FIGS. 3 and 4 will be described with reference to time charts in FIG. 10. In the time charts in FIG. 10, a value obtained at each calculation cycle Tc of the control processing in FIG. 3 is indicated by a black spot.

Both the periodic disturbance and the aperiodic disturbance illustrated in FIG. 10 are disturbances affecting the provisional maximum friction value μpmd to be calculated. For example, when the motor torque fluctuates due to the disturbance as illustrated in FIG. 10, the detected values of physical quantities, which are the basis for the calculation of the calculated friction coefficient μc and the calculated slip rate Sc, also fluctuate, and thus the calculated friction coefficient μc and the calculated slip rate Sc also fluctuate.

Examples of the periodic disturbance include a change in the road surface 84 that is repeated in gravel road travel and sandy beach travel. Examples of the aperiodic disturbance include a case where the tire 81 of the vehicle 80 runs on a pebble and a case where the tire 81 of the vehicle 80 falls into a depression of the road surface 84.

In the time charts in FIG. 10, the provisional maximum friction values μpmd obtained in an accumulation period PDx before a time point ta1 are sequentially stored and accumulated in the storage device 17. Then, the average value μpmdav and the standard deviation σpmd of the provisional maximum friction values μpmd are calculated based on the provisional maximum friction values μpmd stored in the storage device 17.

At the time point ta1 in FIG. 10, the determination result of the step S102 in FIG. 3 is switched from a determination that the average value μpmdav and the standard deviation σpmd of the provisional maximum friction values μpmd have not been calculated to a determination that the average value μpmdav and the standard deviation σpmd have already been calculated. As a result, the determination of the step S104 in FIG. 3, that is, a determination as to whether the provisional maximum friction values μpmd are within the determination range Rj, is made after the time point ta1.

For example, at time points ta2, ta3, and ta4, it is determined in the step S104 in FIG. 3 that the provisional maximum friction values μpmds are out of the determination range Rj. As a result, the provisional maximum friction values μpmd are not adopted as the estimated maximum friction values up, and the previous values of the estimated maximum friction values up are held as they are.

According to the present embodiment, based on the average value μpmdav and the standard deviation σpmd obtained from the provisional maximum friction values μpmd repeatedly calculated, the range determination part 16 determines the determination range Rj including the average value μpmdav, as described above. Then, when the provisional maximum friction value μpmd is within the determination range Rj, the second estimation part 22 determines the provisional maximum friction value μpmd as the estimated maximum friction value μp. On the other hand, when the provisional maximum friction value μpmd is out of the determination range Rj, the second estimation part 22 determines a corrected value, which is a value within the determination range Rj, as the estimated maximum friction value μp.

Therefore, when the provisional maximum friction value μpmd varies aperiodically, the second estimation part 22 determines the corrected value, at which the aperiodic variation is removed, as the estimated maximum friction value μp. Therefore, the estimated maximum friction value μp can be obtained while the influence of the aperiodic disturbance is suppressed. As a result, even during traveling, for example, on a gravel road or the like where aperiodic disturbance is likely to occur, malfunctions in traction control and the like can be avoided.
(1) According to the present embodiment, the second estimation part 22 repeatedly determines the estimated maximum friction value μp every time the provisional maximum friction value μpmd is calculated. In short, the second estimation part 22 repeatedly determines the estimated maximum friction value μp as time passes. The corrected value is the previous value of the estimated maximum friction value μp. Therefore, the estimated maximum friction value μp can be determined by provisionally storing the previous value of the estimated maximum friction value μp, so that it is easy to save memory. In addition, the previous value of the estimated maximum friction value μp has already been calculated and a calculation load for obtaining the corrected value does not occur, so that high-speed calculation is possible.
(2) According to the present embodiment, the first estimation part 11 calculates the friction coefficient μ and the slip rate S of the tire 81 on the basis of the related physical quantities Xa and Xb, and calculates the provisional maximum friction value μpmd on the basis of the calculated friction coefficient μ and slip rate S. Therefore, the related physical quantities Xa and Xb, which are the basis for the calculation of the provisional maximum friction value μpmd, can be obtained from sensors generally provided in the vehicle 80.

### Second Embodiment

Next, a second embodiment will be described. In the present embodiment, differences from the above-described first embodiment will be mainly described. The same or equivalent parts as or to those in the above-described embodiment will be omitted or described in a simplified way. The same is also true for the description of the later-described embodiments.

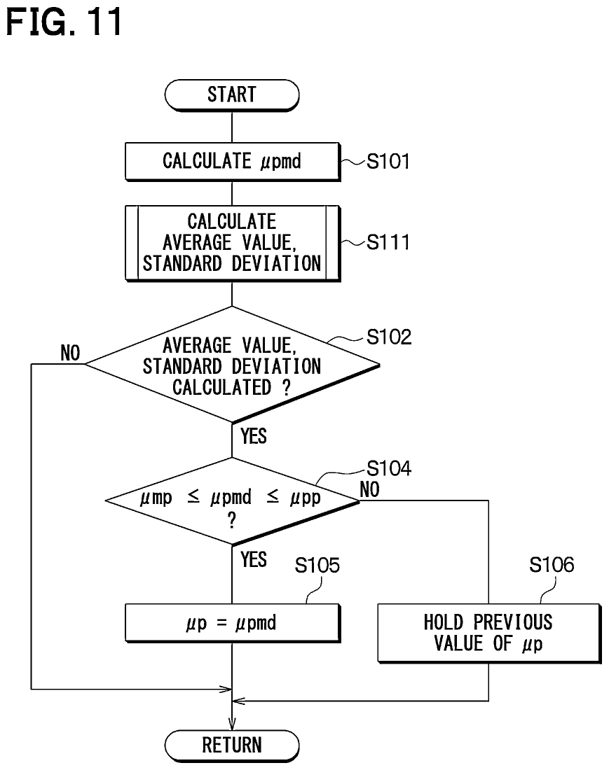

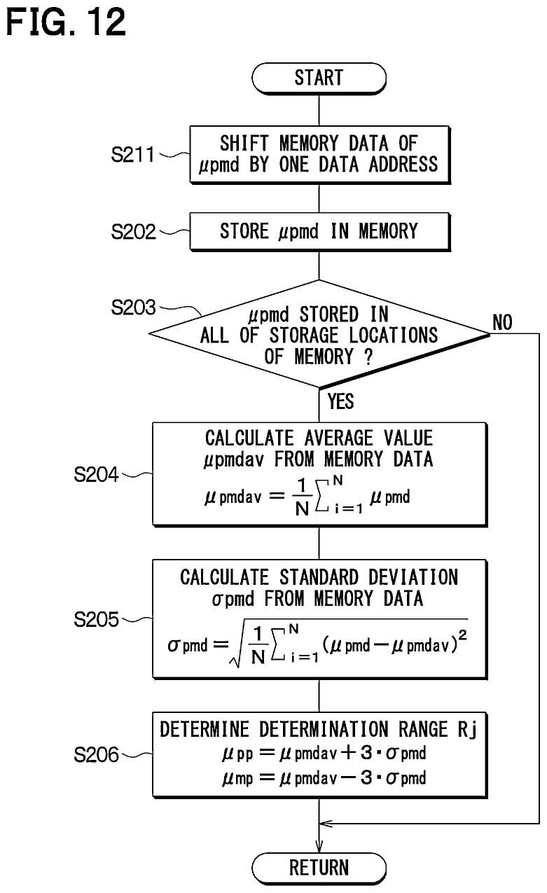

In the present embodiment, the flowchart in FIG. 3 of the first embodiment is replaced with the flowchart in FIG. 11, and the flowchart in FIG. 4 of the first embodiment is replaced with a flowchart in FIG. 12. Also in the present embodiment, a road surface friction estimation device 10 repeatedly executes control processing in FIG. 11 at the predetermined calculation cycle Tc during traveling of the vehicle, thereby sequentially calculating the estimated maximum friction value μp, similarly to the first embodiment.

In the flowchart in FIG. 11, the step S103 in FIG. 3 is omitted, and instead, a step S111 is provided between the step S101 and the step S102. Therefore, after the step S101 in FIG. 11, the processing proceeds to the step S111.

In the step S111 in FIG. 11, a range determination part 16 executes a subroutine in FIG. 12. When the subroutine in FIG. 12 is executed in the step S111 and the subroutine ends and the processing returns to the flowchart in FIG. 11, the processing proceeds from the step S111 to the step S102.

Note that, as described above, the step S103 in FIG. 3 is not provided in the flowchart in FIG. 11. Therefore, when it is determined in the step S102 in FIG. 11 that the average value μpmdav and the standard deviation σpmd of the provisional maximum friction values μpmd have not been calculated, the flowchart in FIG. 11 ends, and the processing starts again from the step S101.

In a step S211 in FIG. 12, the range determination part 16 shifts memory data, which are the provisional maximum friction values μpmd already stored in a storage device 17, to the older memory data side by one data address. In this respect, the step S211 in FIG. 12 is similar to the step S201 in FIG. 4.

In the first embodiment, when the provisional maximum friction values μpmd are stored in all of the storage locations of the storage device 17, the steps S201 and S202 in FIG. 4 are not executed thereafter. In the present embodiment, however, even if the provisional maximum friction values μpmd are stored in all of the storage locations of the storage device 17, the steps S211 and S202 in FIG. 12 may be executed thereafter.

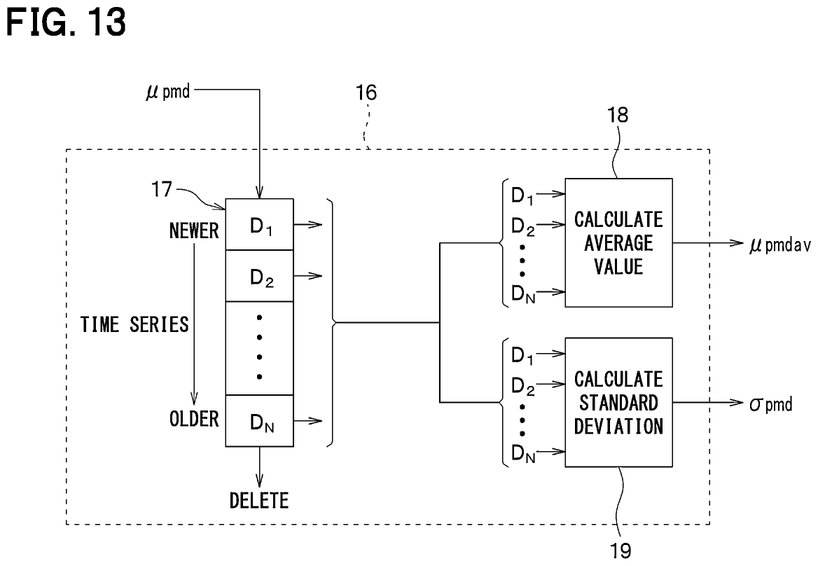

Therefore, in the step S211 in FIG. 12, the range determination part 16 deletes the provisional maximum friction value μpmd stored in the storage location for the oldest memory data D_{N} among the storage locations of the storage device 17 from the storage device 17 as illustrated in FIG. 13, unlike in the step S201 in FIG. 4. The range determination part 16 deletes the data from the storage location for the oldest memory data D_{N} while shifting the memory data to the older memory data side.

Therefore, by executing the step S211 in FIG. 12, for example, the oldest memory data D_{N} is deleted from the storage device 17, memory data D_{N-1} becomes the memory data D_{N}, memory data D₂ becomes memory data D₃, and memory data D₁ becomes memory data D₂. Then, the storage location for the memory data D₁ becomes empty.

The step S211 in FIG. 12 is similar to the step S201 in FIG. 4 except for what have been described above.

A state of the storage device 17, in which the provisional maximum friction values μpmd are stored in all of the storage locations of the storage device 17, is once created, the state is maintained as long as the control processing in FIGS. 11 and 12 continues, because the provisional maximum friction value μpmd is sequentially stored in the storage device 17 as described above. Therefore, once it is determined in the step S203 that the provisional maximum friction values μpmd have been stored in all of the storage locations of the storage device 17, the result of the determination is maintained as long as the control processing in FIGS. 11 and 12 continues.

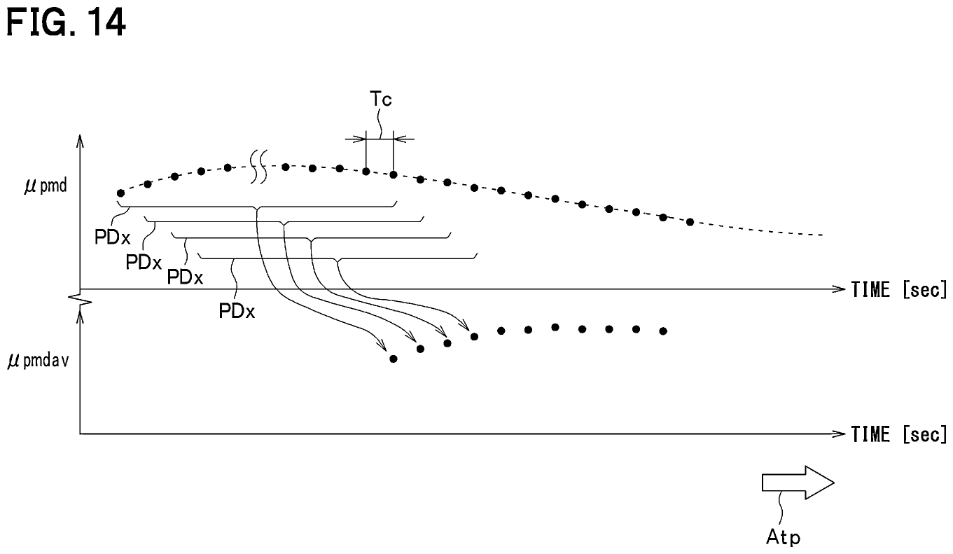

In the present embodiment, the control processing in FIG. 11 is repeatedly executed, and thus the range determination part 16 sequentially stores and accumulates the provisional maximum friction values μpmd obtained within the accumulation period PDx, which is a predetermined period, in the storage device 17, as illustrated in FIGS. 13 and 14. Then, the accumulation period PDx shifts to a side Atp on which time passes every time the provisional maximum friction value μpmd is calculated.

Furthermore, every time the provisional maximum friction value μpmd is calculated, the range determination part 16 determines the determination range Rj of the provisional maximum friction value μpmd on the basis of the average value μpmdav and the standard deviation σpmd obtained from the provisional maximum friction values μpmd calculated within the accumulation period PDx, as illustrated in FIG. 12. In this manner, the range determination part 16 updates the determination range Rj of the provisional maximum friction value μpmd every time the provisional maximum friction value μpmd is calculated.

The road surface friction estimation device 10 of the present embodiment exerts the following effects.
(1) According to the present embodiment, every time the provisional maximum friction value μpmd is calculated, the determination range Rj of the provisional maximum friction value μpmd is repeatedly determined based on the average value μpmdav and the standard deviation σpmd obtained from the provisional maximum friction values μpmd calculated within the accumulation period PDx. Then, the accumulation period PDx shifts to a side Atp on which time passes every time the provisional maximum friction value μpmd is calculated. In other words, the accumulation period PDx shifts to the side Atp, on which time passes, as time passes.

Therefore, it is possible to continue to update the determination range Rj of the provisional maximum friction value μpmd to what is based on the latest provisional maximum friction value μpmd while avoiding the determination range Rj from rapidly changing with the update of the determination range Rj.

The present embodiment is similar to the first embodiment except for what have been described above. In the present embodiment, effects, that are to be exerted by the configuration common to the above-described first embodiment, can be obtained similarly to the first embodiment.

### Third Embodiment

Next, a third embodiment will be described. In the present embodiment, differences from the above-described first embodiment will be mainly described.

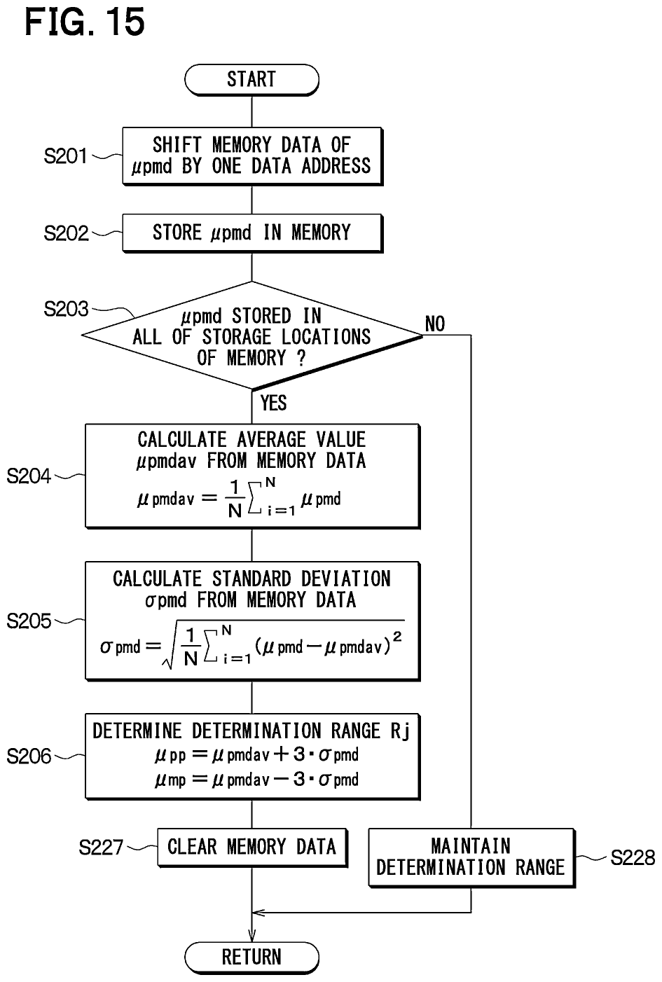

In the present embodiment, the flowchart in FIG. 3 of the first embodiment is replaced with the flowchart in FIG. 11, and the flowchart in FIG. 4 of the first embodiment is replaced with a flowchart in FIG. 15. Also in the present embodiment, a road surface friction estimation device 10 repeatedly executes the control processing in FIG. 11 at the predetermined calculation cycle Tc during traveling of the vehicle, thereby sequentially calculating the estimated maximum friction value μp, similarly to the first embodiment.

The flowchart in FIG. 11 to be adopted in the present embodiment is the flowchart described in the above-described second embodiment. In the present embodiment, a range determination part 16 executes a subroutine in FIG. 15 in the step S111 in FIG. 11, unlike the second embodiment. Except for this, the flowchart in FIG. 11 of the present embodiment is as described in the second embodiment.

In the flowchart in FIG. 15 of the present embodiment, a step S227 and a step S228 are added to the flowchart in FIG. 4 of the first embodiment. Note that the configuration of the range determination part 16 of the present embodiment is as illustrated in FIG. 6 as in the first embodiment.

The processing of the flowchart in FIG. 15 proceeds to the step S227 when a step S206 ends. Then, in the step S227 in FIG. 15, the range determination part 16 executes memory data clear on the storage device 17 in FIG. 6. That is, the range determination part 16 deletes, from all of the storage locations of the storage device 17, the provisional maximum friction values μpmd stored therein. As a result, the storage device 17 returns from the state in which the provisional maximum friction values μpmd are stored in all of the storage locations of the storage device 17 to the initial state in which the provisional maximum friction values μpmd are not stored at all. Therefore, in the next step S203 after the storage device 17 returns to the initial state, it is determined again that there is still an empty location in the storage locations of the storage device 17. When the step S227 ends, the subroutine in FIG. 15 ends and the processing returns to the flowchart in FIG. 11.

When it is determined in the step S203 in FIG. 15 that the provisional maximum friction values μpmd are not stored in all of the storage locations of the storage device 17 and there is still an empty location in the storage locations of the storage device 17, the processing proceeds to the step S228.

When the average value μpmdav and the standard deviation σpmd of the provisional maximum friction values μpmd and the determination range Rj have already been calculated or determined, the range determination part 16 maintains the average value μpmdav, the standard deviation σpmd, and the determination range Rj as they are in the step S228. When the average value μpmdav and the standard deviation σpmd of the provisional maximum friction values μpmd and the determination range Rj have not been calculated or determined yet, the range determination part 16 maintains the state, in which the calculation or determination has not been made, as it is. In short, the range determination part 16 does nothing in the step S228. When the step S228 ends, the subroutine in FIG. 15 ends and the processing returns to the flowchart in FIG. 11.

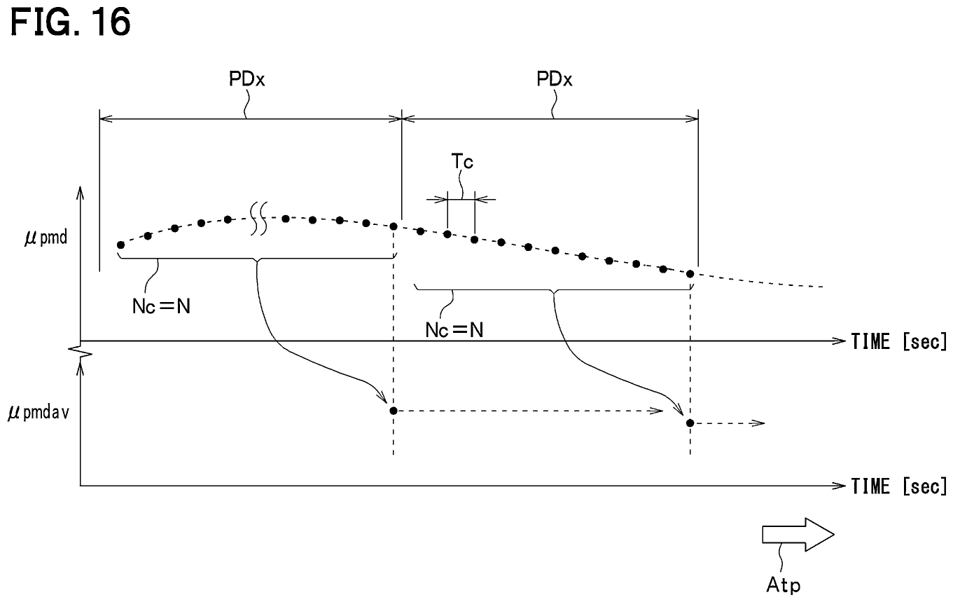

Since the flowchart in FIG. 11 described above is repeatedly executed, the range determination part 16 updates the average value μpmdav and the standard deviation σpmd of the provisional maximum friction values μpmd and the determination range Rj every time a predetermined calculation number Nc of the provisional maximum friction values μpmd are stored in the storage device 17, as illustrated in FIGS. 6 and 16. Then, the updated average value μpmdav, standard deviation σpmd, and determination range Rj are calculated or determined on the basis of the provisional maximum friction values μpmd stored in the storage device 17 at the time of the update.

Note that the predetermined calculation number Nc is the same as the number of the storage locations of the storage device 17, and thus “the calculation number Nc=N” holds.

Since the provisional maximum friction value μpmd is sequentially stored in the storage device 17 at the predetermined calculation cycle Tc, the predetermined calculation number Nc can be converted into time. Therefore, the “every time the predetermined calculation number Nc of the provisional maximum friction values μpmd are stored in the storage device 17” can be rephrased as every accumulation period PDx corresponding to the predetermined calculation number Nc. In this case, the accumulation period PDx in the present embodiment is defined as a predetermined period in which the provisional maximum friction values μpmd are continuously accumulated in the storage device 17.

Furthermore, after the average value μpmdav, the standard deviation σpmd, and the determination range Rj are updated, the range determination part 16 erases all of the provisional maximum friction values μpmd stored in the storage device 17, and then starts to store the provisional maximum friction value μpmd again in the storage device 17. Therefore, as illustrated in FIG. 16, the accumulation period PDx shifts to the side Atp, on which time passes, as time passes.

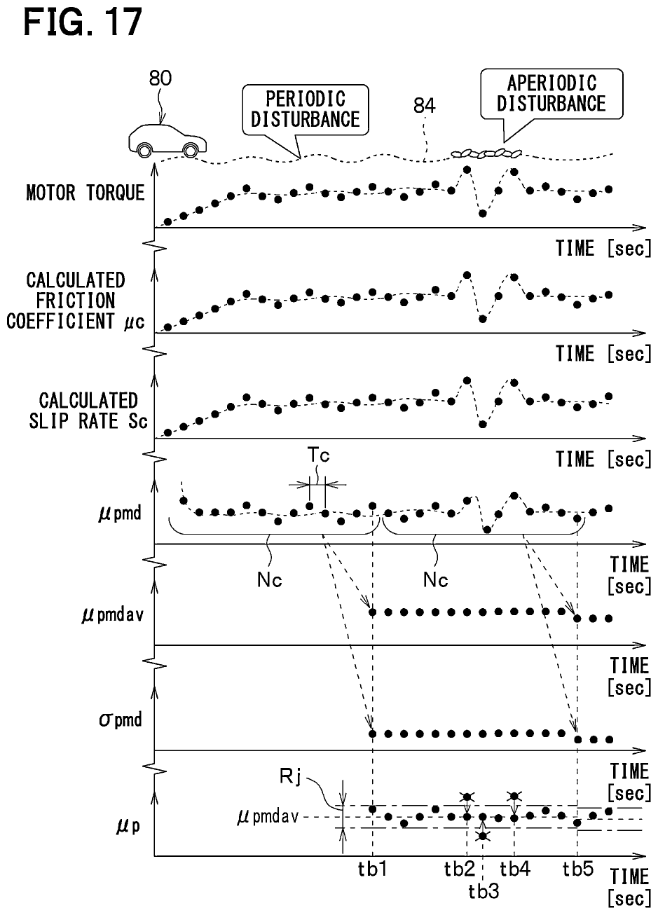

Next, the control processing in FIGS. 11 and 15 described above will be described with reference to time charts in FIG. 17. In the time charts in FIG. 17, a value obtained at each calculation cycle Tc of the control processing in FIG. 11 is indicated by a black spot. The time charts in FIG. 17 correspond to those in FIG. 10 described above, and similarly to FIG. 10, periodic disturbance and aperiodic disturbance affecting the provisional maximum friction value μpmd respectively occur.

At a time point tb1 in FIG. 17, it is determined in the step S203 in FIG. 15 that the provisional maximum friction values μpmd have been stored in all of the storage locations of the storage device 17 for the first time since the start of the control processing in FIGS. 11 and 15. As a result, the average value μpmdav and the standard deviation σpmd of the provisional maximum friction values μpmd are calculated, and the determination range Rj is determined based on them. The average value μpmdav, the standard deviation σpmd, and the determination range Rj at the time point tb1 are maintained until before a time point tb5 that is the next update time point, and are updated at the time point tb5.

In the time charts in FIG. 17, for example, at time points tb2, tb3, and tb4, it is determined in a step S104 in FIG. 11 that the provisional maximum friction values μpmd are out of the determination range Rj. As a result, the provisional maximum friction values μpmd are not adopted as the estimated maximum friction values up, and the previous values of the estimated maximum friction values up are held as they are.

The road surface friction estimation device 10 of the present embodiment exerts the following effects.
(1) According to the present embodiment, the storage device 17 sequentially stores the provisional maximum friction value μpmd every time a provisional value calculation part 14 calculates the provisional maximum friction value μpmd in the step S101. The range determination part 16 updates the average value μpmdav and the standard deviation σpmd of the provisional maximum friction values μpmd and the determination range Rj every time the predetermined calculation number Nc of the provisional maximum friction values μpmd are stored in the storage device 17. Then, the updated average value μpmdav, standard deviation σpmd, and determination range Rj are calculated or determined on the basis of the provisional maximum friction values μpmd stored in the storage device 17 at the time of the update. Furthermore, after the average value μpmdav, the standard deviation σpmd, and the determination range Rj are updated, the range determination part 16 starts to store the calculation number Nc of the provisional maximum friction values μpmd again in the storage device 17.

That is, every time the predetermined calculation number Nc of the provisional maximum friction values μpmd are stored in the storage device 17, the range determination part 16 determines the determination range Rj on the basis of the average value μpmdav and the standard deviation σpmd obtained from the calculation number Nc of the provisional maximum friction values μpmd stored in the storage device 17.

Therefore, compared to a case where the determination range Rj is updated every time the provisional maximum friction value μpmd is calculated, the determination range Rj can be appropriately updated so as to be less affected by the old provisional maximum friction value μpmd calculated in the past by suppressing a calculation load.

The present embodiment is similar to the first embodiment except for what have been described above. In the present embodiment, effects, that are to be exerted by the configuration common to the above-described first embodiment, can be obtained similarly to the first embodiment.

### Fourth Embodiment

Next, a fourth embodiment will be described. In the present embodiment, differences from the above-described third embodiment will be mainly described.

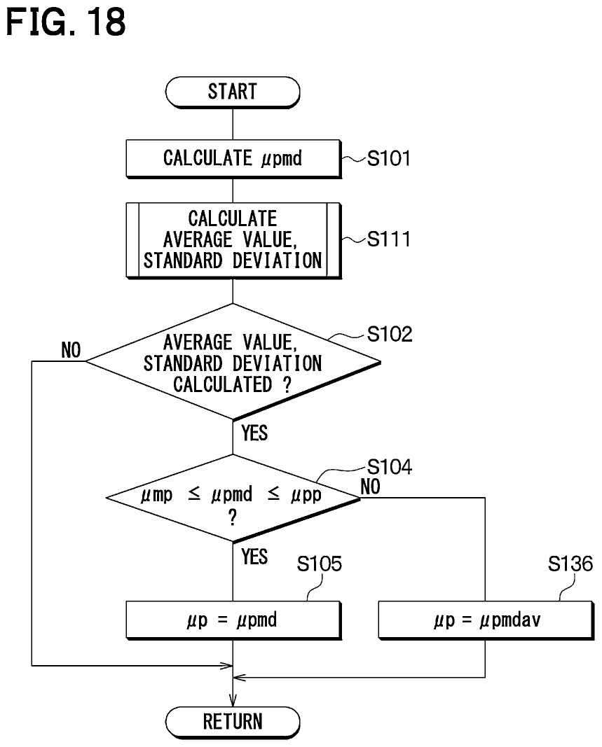

In the present embodiment, the flowchart in FIG. 11 of the third embodiment is replaced with a flowchart in FIG. 18. Also in the present embodiment, a road surface friction estimation device 10 repeatedly executes control processing in FIG. 18 at the predetermined calculation cycle Tc during traveling of the vehicle, thereby sequentially calculating the estimated maximum friction value μp, similarly to the third embodiment. In the present embodiment, the flowchart in FIG. 15 that is the same as that of the third embodiment is adopted as a subroutine to be executed in a step S111 in FIG. 18.

In the flowchart in FIG. 18 of the present embodiment, the step S106 of the flowchart in FIG. 11 of the third embodiment is replaced with a step S136. Therefore, when it is determined in a step S104 in FIG. 18 that the provisional maximum friction value μpmd is out of the determination range Rj, the processing proceeds to the step S136.

In the step S136, a second estimation part 22 determines a corrected value, which is a value within the determination range Rj, as the estimated maximum friction value μp. In the present embodiment, the corrected value is defined as the average value μpmdav of the provisional maximum friction values μpmd calculated in a step S204 in FIG. 15.

When the step S136 ends, the flowchart in FIG. 18 ends and the processing starts from a step S101 again.

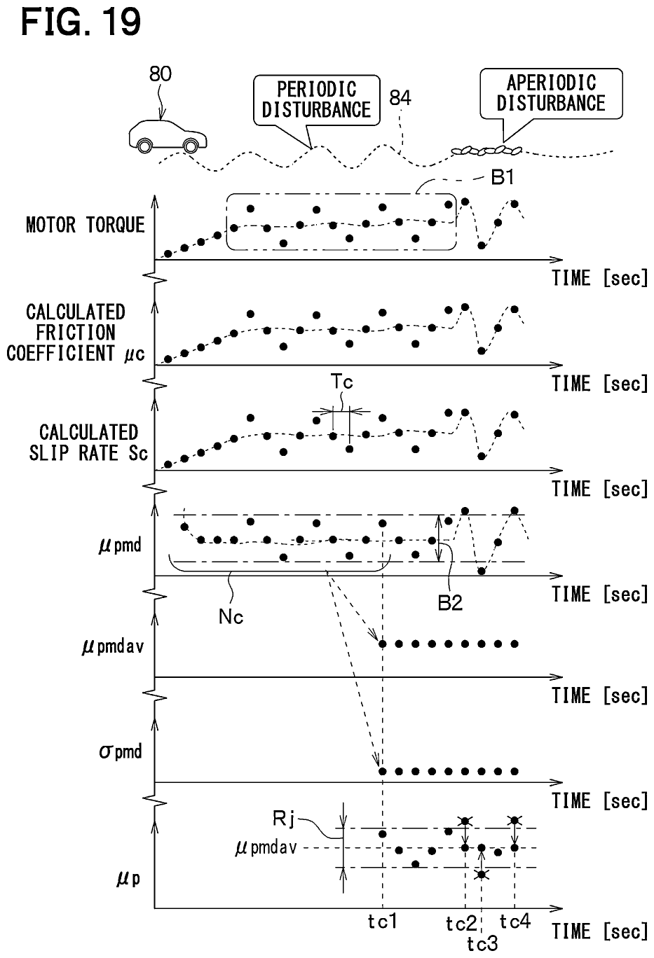

Next, the control processing in FIGS. 15 and 18 described above will be described with reference to time charts in FIG. 19. In the time charts in FIG. 19, a value obtained at each calculation cycle Tc of the control processing in FIG. 18 is indicated by a black spot. The time charts in FIG. 19 correspond to those in FIG. 17 described above.

At a time point tc1 in FIG. 19, the average value μpmdav and the standard deviation σpmd of the provisional maximum friction values μpmd are calculated, and the determination range Rj is determined based on them, similarly to the time point tb1 in FIG. 17.

In the time charts in FIG. 19, at respective time points tc2, tc3, and tc4, it is determined in the step S104 in FIG. 18 that the provisional maximum friction values μpmd are out of the determination range Rj, similarly to the time points tb2, tb3, and tb4 in FIG. 17.

As a result, at the time points tc2, tc3, and tc4 of the time charts in FIG. 19, the provisional maximum friction values μpmd are not adopted as the estimated maximum friction values up. This is similar to the time points tb2, tb3, and tb4 in FIG. 17. However, at the respective time points tc2, tc3, and tc4 in FIG. 19, the average value μpmdav of the provisional maximum friction values μpmd is adopted as the estimated maximum friction value μp, unlike the time points tb2, tb3, and tb4 in FIG. 17.

The road surface friction estimation device 10 of the present embodiment exerts the following effects.
(1) According to the present embodiment, the second estimation part 22 determines in the step S136 in FIG. 18 the average value μpmdav of the provisional maximum friction values μpmd calculated in the step S204 in FIG. 15 as the estimated maximum friction value μp.

Here, for example, when periodic disturbance is large, the fluctuation of the motor torque increases as indicated by a range B1 in FIG. 19, and as a result, the variation in the provisional maximum friction value μpmd also increases as indicated by an arrow B2 in FIG. 19. In such a case, for example, if a value near the end of the determination range Rj, despite being within the determination range Rj of the provisional maximum friction value μpmd, continues as the estimated maximum friction value μp, a disturbance removal effect of removing disturbance from the estimated maximum friction value μp is diluted.

On the other hand, in the present embodiment, the average value μpmdav becomes the estimated maximum friction value μp in the step S136 as described above, and thus a value near the end of the determination range Rj is difficult to continue as the estimated maximum friction value μp. Therefore, compared to a case where, for example, the previous value of the estimated maximum friction value μp is maintained as it is, the estimated maximum friction value μp can be determined while an influence of a large variation in the provisional maximum friction value μpmd is suppressed. Note that, as a case where periodic disturbance increases, for example, a case, where the road surface 84 on which the vehicle 80 travels is a rough gravel road or a fresh snow road, is assumed.

The present embodiment is similar to the third embodiment except for what have been described above. In the present embodiment, effects, that are to be exerted by the configuration common to the above-described third embodiment, can be obtained similarly to the third embodiment.

Although the present embodiment is a modification based on the third embodiment, the present embodiment can also be combined with the first embodiment or the second embodiment described above.

### Fifth Embodiment

Next, a fifth embodiment will be described. In the present embodiment, differences from the above-described second embodiment will be mainly described.

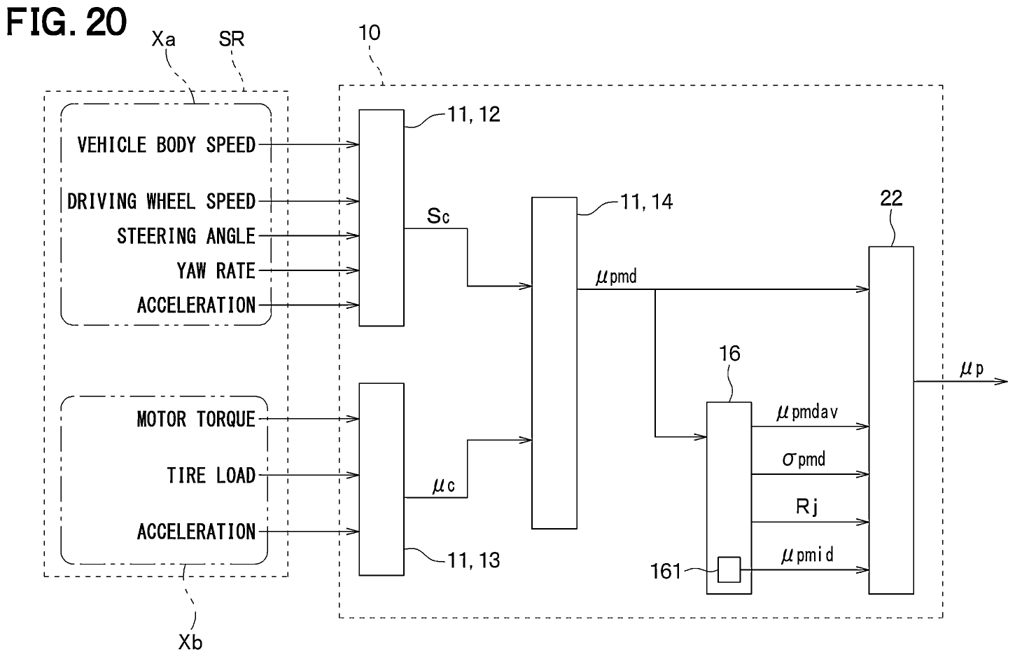

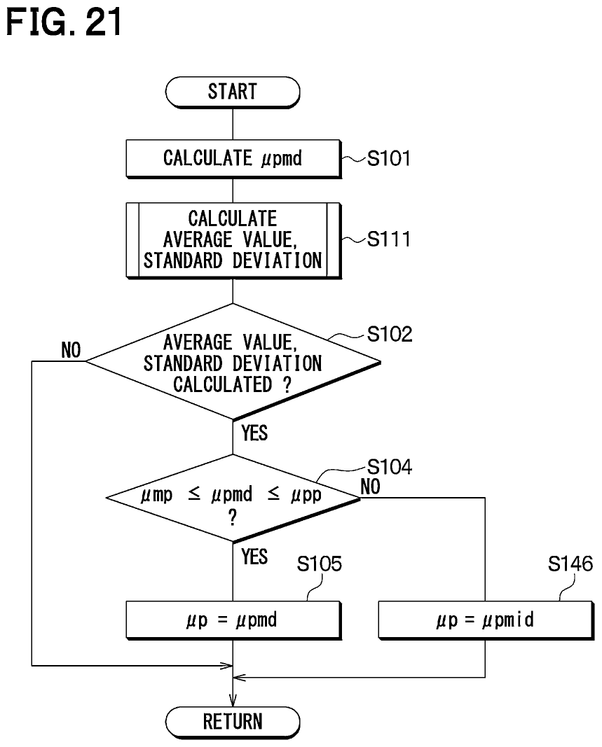

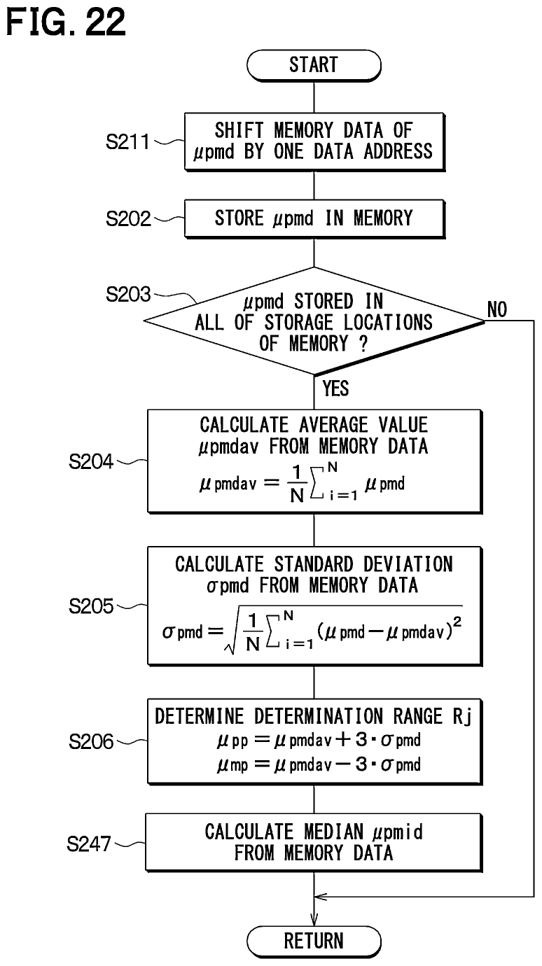

In the present embodiment, the block diagram in FIG. 2 of the second embodiment is replaced with a block diagram in FIG. 20, the flowchart in FIG. 11 of the second embodiment is replaced with a flowchart in FIG. 21, and the flowchart in FIG. 12 of the second embodiment is replaced with a flowchart in FIG. 22.

Also in the present embodiment, a road surface friction estimation device 10 repeatedly executes control processing in FIG. 21 at the predetermined calculation cycle Tc during traveling of the vehicle, thereby sequentially calculating the estimated maximum friction value μp, similarly to the second embodiment. In the present embodiment, a subroutine executed in a step S111 in FIG. 21 is the flowchart in FIG. 22. The configuration of a storage device 17 of the present embodiment is similar to that of the storage device 17 of the second embodiment illustrated in FIG. 13.

In the flowchart in FIG. 22, after a step S206, the processing proceeds to a step S247. A range determination part 16 in FIG. 20 includes a median calculation part 161, and the median calculation part 161 calculates, in the step S247 in FIG. 22, a median μpmid of memory data D₁ to D_{N} that are the provisional maximum friction values μpmd stored in a storage device 17. In other words, the memory data D₁ to D_{N}, are the provisional maximum friction values μpmd stored in the storage device 17, and are the provisional maximum friction values μpmd that have been the basis for the average value μpmdav calculated in the step S204.

When the step S247 ends, the subroutine in FIG. 22 ends and the processing returns to the flowchart in FIG. 21.

In the flowchart in FIG. 21 of the present embodiment, the step S106 of the flowchart in FIG. 11 of the second embodiment is replaced with a step S146. Therefore, when it is determined in a step S104 in FIG. 21 that the provisional maximum friction value μpmd is out of the determination range Rj, the processing proceeds to the step S146.

In the step S146, a second estimation part 22 determines the median μpmid of the provisional maximum friction values μpmd calculated in the step S247 in FIG. 22 as the estimated maximum friction value μp. In short, the estimated maximum friction value μp is defined as the median μpmid of the provisional maximum friction values μpmd.

When the step S146 ends, the flowchart in FIG. 21 ends and the processing starts from a step S101 again.

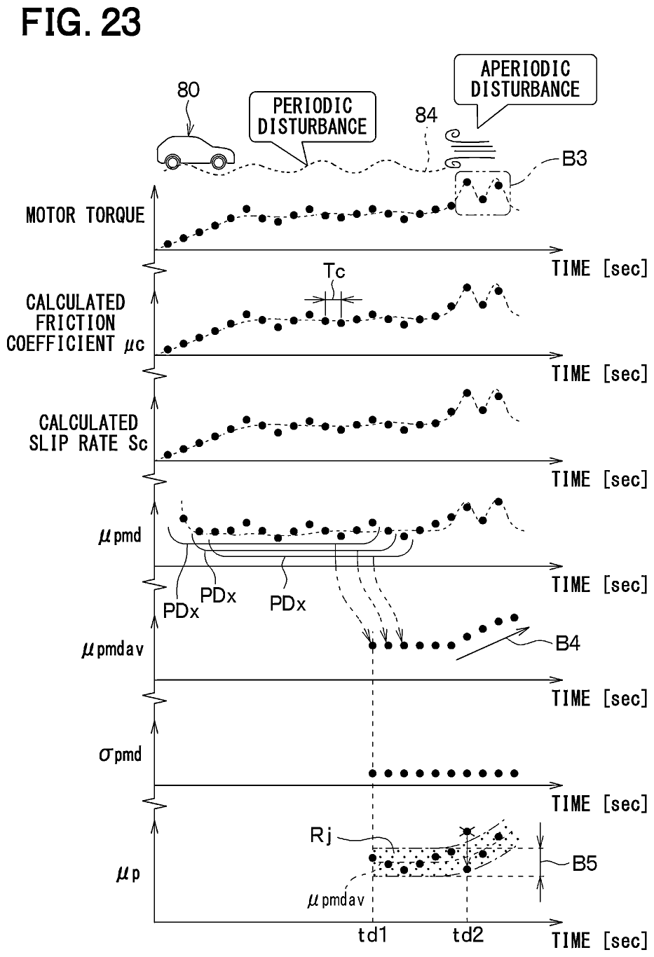

Next, the control processing in FIGS. 21 and 22 described above will be described with reference to time charts in FIG. 23. The time charts in FIG. 23 correspond to those in FIG. 19 of the above-described fourth embodiment. In the time charts in FIG. 23, a value obtained at each calculation cycle Tc of the control processing in FIG. 21 is indicated by a black spot.

At a time point td1 in FIG. 23, the average value μpmdav and the standard deviation σpmd of the provisional maximum friction values μpmd are calculated, and the determination range Rj is determined based on them, similarly to the time point tc1 in FIG. 19.

In addition, at a time point td2 of the time charts in FIG. 23, it is determined in the step S104 in FIG. 21 that the provisional maximum friction value μpmd is out of the determination range Rj, similarly to the time point tc2 in FIG. 19.

As a result, at the time point td2 of the time charts in FIG. 23, the provisional maximum friction value μpmd is not adopted as the estimated maximum friction value μp. This is similar to the time point tc2 in FIG. 19. However, at the time point td2 in FIG. 23, the median μpmid of the provisional maximum friction values μpmd is adopted as the estimated maximum friction value μp in the step S146 in FIG. 21, unlike the time point tc2 in FIG. 19.

The road surface friction estimation device 10 of the present embodiment exerts the following effects.
(1) According to the present embodiment, the second estimation part 22 determines, in the step S146 in FIG. 21, the median μpmid of the provisional maximum friction values μpmd calculated in the step S247 in FIG. 22 as the estimated maximum friction value μp.

Therefore, when the provisional maximum friction value μpmd varies aperiodically, the second estimation part 22 determines the median μpmid, at which the influence of the aperiodic variation in the provisional maximum friction value μpmd is diluted, as the estimated maximum friction value μp. Therefore, the estimated maximum friction value μp can be obtained while the influence of the aperiodic disturbance is suppressed.

Here, for example, immediately after aperiodic disturbance, occurring when the vehicle 80 receives a headwind while traveling at high speed, is superimposed, the motor torque may temporarily greatly fluctuate as illustrated in a range B3 in FIG. 23, and the average value μpmdav may be strongly affected by the disturbance as indicated by an arrow B4. In addition, if a value near the end of the determination range Rj, despite being within the determination range Rj of the provisional maximum friction value μpmd, continues as the estimated maximum friction value μp, a disturbance removal effect of removing disturbance from the estimated maximum friction value μp is diluted.

Therefore, in the present embodiment, the estimated maximum friction value μp is defined as the median μpmid of the provisional maximum friction values μpmd in the step S146 in FIG. 21, as described above. As a result, compared to a case where the estimated maximum friction value μp is defined as, for example, the previous value of the estimated maximum friction value μp or the average value μpmdav of the provisional maximum friction values μpmd, temporal influence of aperiodic disturbance on the estimated maximum friction value μp, that occurs immediately after the disturbance is superimposed, can be more reduced. A range B5 illustrated in FIG. 23 indicates the determination range Rj of the provisional maximum friction value μpmd that is obtained when there is no aperiodic disturbance or after a while after the aperiodic disturbance subsides.

The present embodiment is similar to the second embodiment except for what have been described above. In the present embodiment, effects, that are to be exerted by the configuration common to the above-described second embodiment, can be obtained similarly to the second embodiment.

Although the present embodiment is a modification based on the second embodiment, the present embodiment can also be combined with the first embodiment or the third embodiment described above.

### Sixth Embodiment

Next, a sixth embodiment will be described. In the present embodiment, differences from the above-described third embodiment will be mainly described.

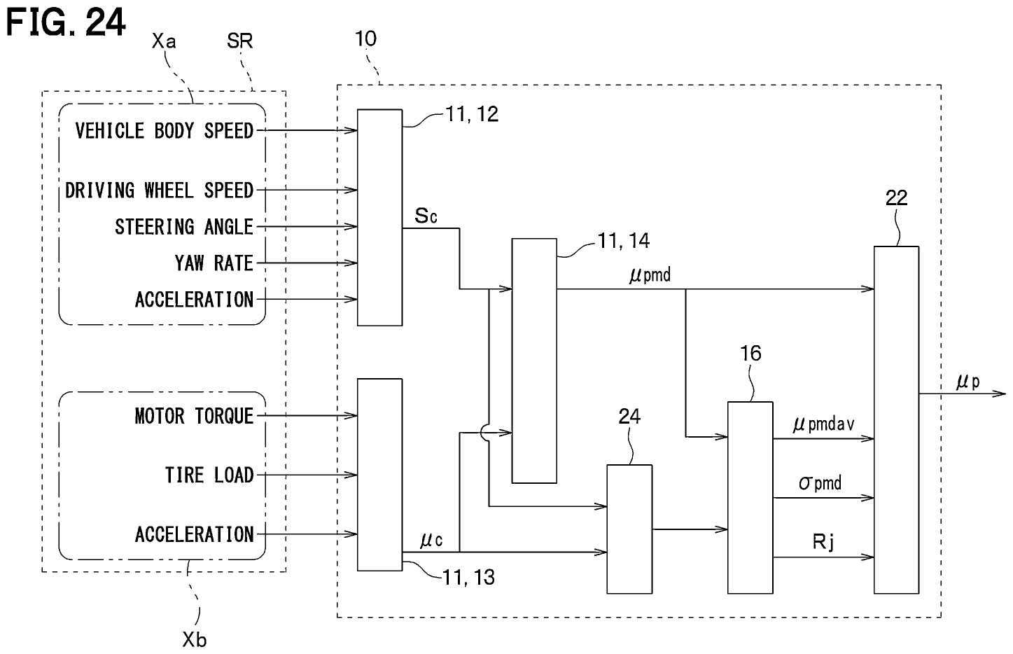

In the present embodiment, the determination range Rj of the provisional maximum friction value μpmd is determined in consideration of switching of the road surface 84 on which the vehicle 80 is traveling. Therefore, a road surface friction estimation device 10 of the present embodiment includes a road surface determination part 24 that determines whether switching of the road surface 84 has occurred, as illustrated in FIG. 24.

Here, for comparison with the present embodiment, a road surface friction estimation device of a comparative example, in which switching of the road surface 84 on which the vehicle 80 without the road surface determination part 24 in FIG. 24 is traveling is not taken into consideration, is assumed.

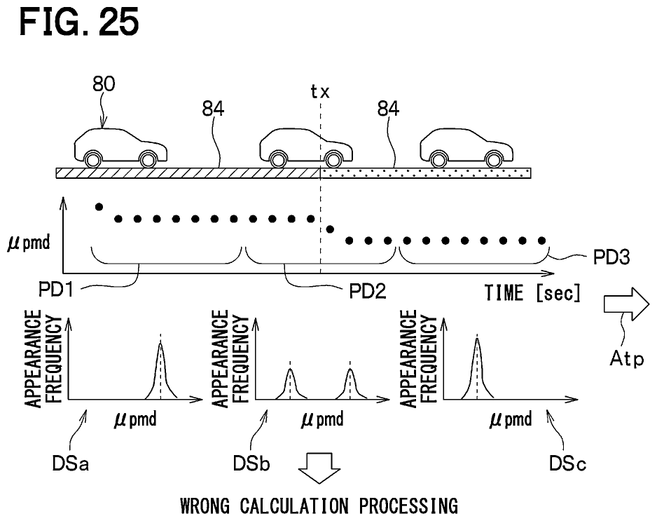

A case where, as illustrated, for example, in FIG. 25, the road surface 84 is switched at a time point tx while the vehicle 80 is traveling, will be described as an example. Within a first period PD1 before the time point tx, the distribution of the provisional maximum friction values μpmd is as illustrated in a distribution map DSa. Within a second period PD2 straddling the time point tx, the distribution of the provisional maximum friction values μpmd is as illustrated in a distribution map DSb. Within a third period PD3 after the time point tx, the distribution of the provisional maximum friction values μpmd is as illustrated in a distribution map DSc.

In the above comparative example, the switching of the road surface 84 is not taken into consideration, and thus, even for a distribution in which the provisional maximum friction values μpmd have multiple appearance frequency peaks as in the distribution map DSb in the second period PD2, the average value μpmdav and the standard deviation σpmd are calculated based on the provisional maximum friction values μpmd. Then, an inappropriate determination range Rj of the provisional maximum friction value μpmd is temporarily set. That is, in the above-described comparative example, calculation processing for determining the determination range Rj is temporarily wrong.

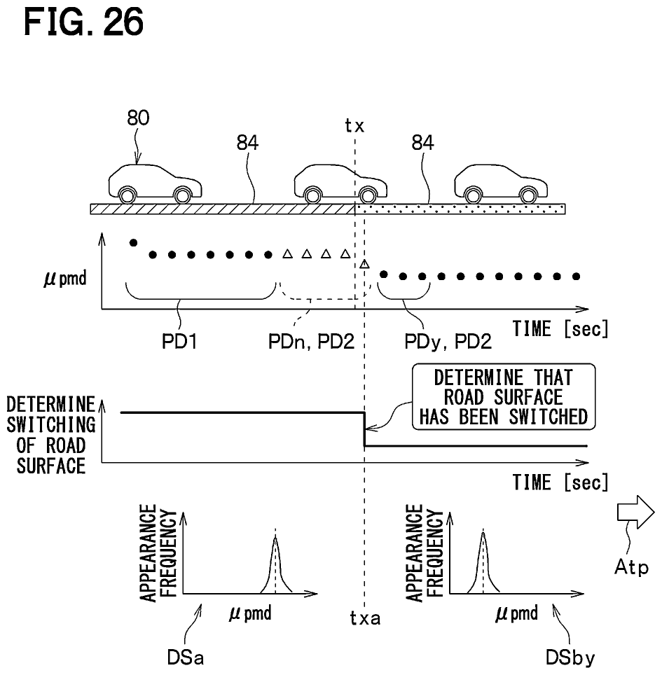

On the other hand, in the present embodiment, the road surface determination part 24 determines that the road surface 84 has been switched at a time point txa immediately after the time point tx when the road surface 84 is switched, as illustrated in FIG. 26. In the present embodiment, the average value μpmdav and the standard deviation σpmd are calculated by this determination on the basis of one or more provisional maximum friction values μpmd excluding the provisional maximum friction value μpmd obtained before the switching of the road surface 84 occurs.

In the example in FIG. 26, a combination of an exclusion period PDn and an adoption period PDy constitutes the second period PD2 in FIG. 25. The exclusion period PDn includes the time point tx, but the adoption period PDy does not include the time point tx and is a period that starts after the time point tx. In the present embodiment, the provisional maximum friction value μpmd within the exclusion period PDn of the second period PD2 is not used for calculating the average value μpmdav and the standard deviation σpmd, and the provisional maximum friction value μpmd within the adoption period PDy is used for calculating the average value μpmdav and the standard deviation σpmd. As a result, the distribution of the provisional maximum friction values μpmd within the second period PD2 used for calculating the average value μpmdav and the standard deviation σpmd is similar to that after the switching of the road surface 84 as in a distribution map DSby, and thus an inappropriate determination range Rj can be avoided from being temporarily set.

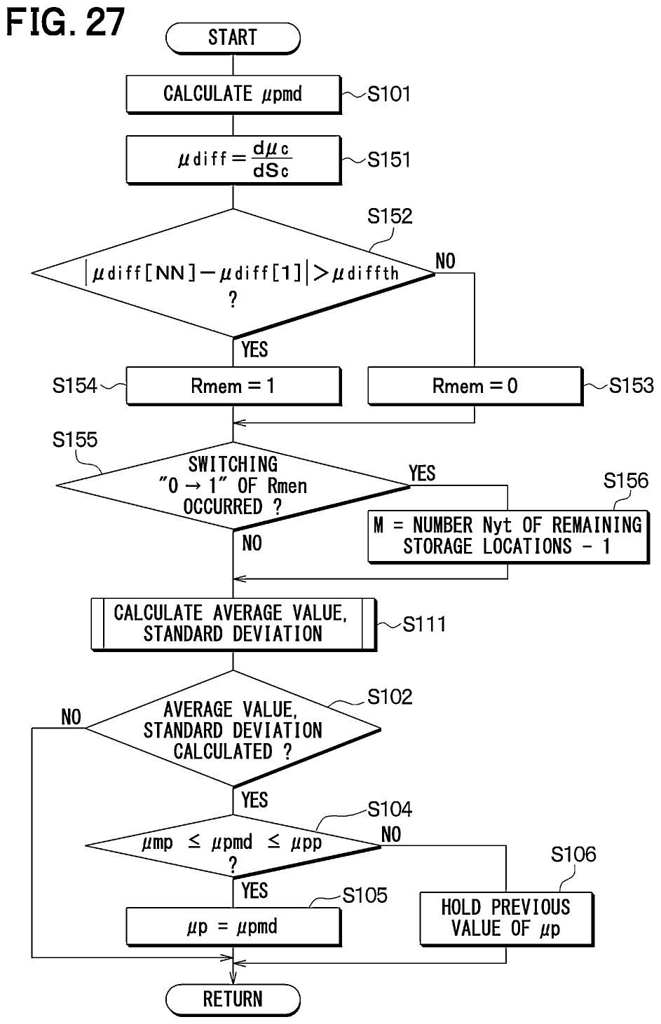

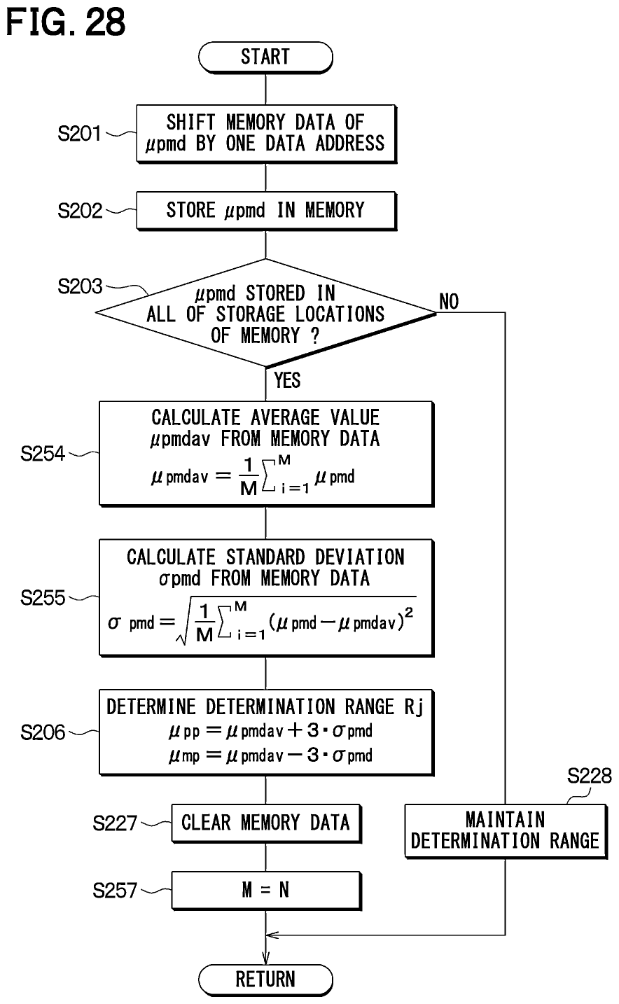

In order to perform the processing as described above in the present embodiment, the flowchart in FIG. 11 of the third embodiment is replaced with a flowchart in FIG. 27, and the flowchart in FIG. 15 of the third embodiment is replaced with a flowchart in FIG. 28. Also in the present embodiment, the road surface friction estimation device 10 repeatedly executes control processing in FIG. 27 at the predetermined calculation cycle Tc during traveling of the vehicle, thereby sequentially calculating the estimated maximum friction value μp, similarly to the third embodiment. In the present embodiment, a subroutine executed in a step S111 in FIG. 27 is the flowchart in FIG. 28.

In the flowchart in FIG. 27 of the present embodiment, steps S151 to S156 are provided between steps S101 and S111. Therefore, after the step S101 of the flowchart in FIG. 27, the processing proceeds to a step S151.

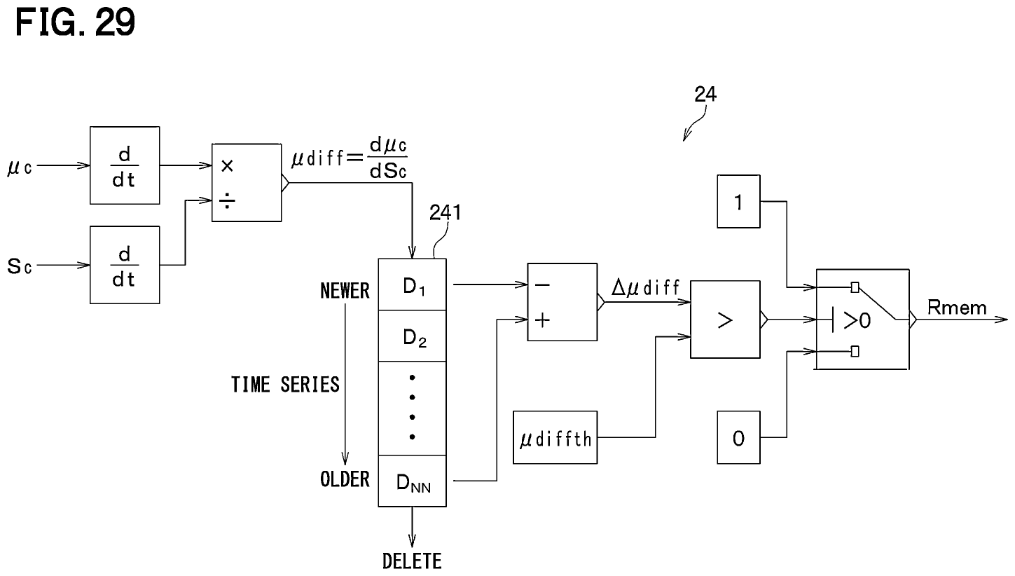

In the step S151 in FIG. 27, the road surface determination part 24 first calculates a time differential value dμc/dt of a calculated friction coefficient μc calculated in the step S101 and a time differential value dSc/dt of a calculated slip rate Sc, as illustrated in FIG. 29. Then, the road surface determination part 24 calculates a determination parameter μdiff from a following formula F6.

$$μ diff = d μ c / dSc = ( d μ c / dt ) / ( dSc / dt ) \qquad ( F6 )$$

After calculating the determination parameter μdiff, the road surface determination part 24 stores the determination parameter μdiff in a determination storage device 241 included in the road surface determination part 24. The determination storage device 241 basically has a configuration similar to that of the storage device 17 in FIG. 13. In detail, the determination storage device 241 is different from the storage device 17 in FIG. 13 in that the memory data to be stored is the determination parameter μdiff and that the number of storage locations for the memory data is NN, but other configurations are similar to those of the storage device 17 in FIG. 13.

Therefore, the determination storage device 241 stores the determination parameters μdiff in time series. Specifically, D₁, D₂, . . . , and D_{NN} in FIG. 29 each represent memory data that is the stored determination parameter μdiff. A subscript “1, 2, . . . , or NN” of D represents a data address, which means that the smaller the value of the subscript, the newer the stored determination parameter μdiff.

Every time the determination parameter μdiff is calculated, the memory data D₁, for example, is updated to the latest of the determination parameters μdiff calculated sequentially. At the same time, the memory data D_{NN} is updated every time the determination parameter μdiff is calculated so as to be the determination parameter μdiff calculated a certain time before the memory data D₁ is calculated. After the step S151 in FIG. 27, the processing proceeds to the step S152.

In the step S152, the road surface determination part 24 first calculates a determination parameter difference Δμdiff from the following formula F7 using the determination parameter μdiff stored in the determination storage device 241, as illustrated in FIG. 29.

$$Δμ diff = \vert ( μ diff [ NN ] - μ diff [ 1 ] ) \vert \qquad ( F7 )$$

Here, μdiff [1] in the above formula F7 is the determination parameter μdiff stored in the first storage location of the determination storage device 241, that is, the latest determination parameter μdiff stored in the determination storage device 241. This μdiff [1] is represented as the memory data Di in FIG. 29. In addition, μdiff [NN] in the above formula F7 is the determination parameter μdiff stored in the NN-th storage location of the determination storage device 241, that is, the oldest determination parameter μdiff stored in the determination storage device 241. This μdiff [NN] is represented as the memory data D_{NN} in FIG. 29.

When calculating the determination parameter difference Δμdiff in the step S152, the road surface determination part 24 determines whether the determination parameter difference Δμdiff is larger than a predetermined road surface change determination value μdiffth, as illustrated in FIGS. 27 and 29. As a result, the road surface determination part 24 determines whether a state change in the road surface 84, in which the state of friction between the road surface 84 and the tire 81 changes beyond a predetermined limit, has occurred, that is, whether the road surface 84 on which the vehicle 80 is traveling has been switched. That is, the road surface change determination value μdiffth is set corresponding to the predetermined limit on the state of friction, and is experimentally set in advance so that switching of the road surface 84 on which the vehicle is traveling can be determined.

When it is determined in the step S152 that the determination parameter difference Δμdiff is larger than the road surface change determination value μdiffth, the processing proceeds to the step S154. On the other hand, when it is determined that the determination parameter difference Δμdiff is equal to or smaller than the road surface change determination value μdiffth, the processing proceeds to the step S153.

Note that, at the beginning when the control processing in FIG. 27 is started, a period, in which μdiff [NN] in the above formula F7 is not determined, occurs. Therefore, until the determination parameters μdiff are stored in all of the storage locations of the determination storage device 241 after the control processing in FIG. 27 is started, the determination in the step S152 is not made, and the processing uniformly proceeds to the step S153 after the step S152.

In the step S153 in FIG. 27, the road surface determination part 24 sets a flag variable Rmem to “Rmem=0”, as illustrated in FIGS. 27 and 29. On the other hand, in the step S154 in FIG. 27, the road surface determination part 24 sets the flag variable Rmem to “Rmem=1”. After the step S153 or the step S154, the processing proceeds to the step S155.

In the step S155 in FIG. 27, the road surface determination part 24 determines whether the flag variable Rmem has been switched from “Rmem=0” to “Rmem=1”. The fact that the flag variable Rmem has been switched from “Rmem=0” to “Rmem=1” means that the state of friction between the road surface 84 and the tire 81 has changed beyond the predetermined limit, that is, the above-described state change in the road surface 84 has occurred. The case where the flag variable Rmem is switched from “Rmem=0” to “Rmem=1” is, in other words, a case where the previous value of the flag variable Rmem is 0 and the current value of the flag variable Rmem is 1.

When it is determined in the step S155 that the flag variable Rmem has been switched from “Rmem=0” to “Rmem=1”, the processing proceeds to the step S156. On the other hand, when it is determined that the flag variable Rmem has not been switched from “Rmem=0” to “Rmem=1”, the processing proceeds to the step S111. The case where the flag variable Rmem has not been switched from “Rmem=0” to “Rmem=1” is a case where the flag variable Rmem remains at “Rmem=0” or “Rmem=1”, or a case where the flag variable Rmem has been switched from “Rmem=1” to “Rmem=0”.

In the step S156 in FIG. 27, the road surface determination part 24 first reads, among all of the storage locations in the storage device 17 in FIG. 6, a number Nyt of empty storage locations in which the provisional maximum friction values μpmd are not yet stored, that is, a number Nyt of remaining storage locations. Then, the road surface determination part 24 determines a calculation target number M from the following formula F8 on the basis of the number Nyt of remaining storage locations. Compared to N that is the total number of the storage locations included in the storage device 17, the calculation target number M is always “M≤N”.

$$M = Nyt - 1 \qquad ( F8 )$$

The calculation target number M is a variable to be used in the later-described formula F9 for calculating the average value μpmdav of the provisional maximum friction values μpmd and the later-described formula F10 for calculating the standard deviation σpmd. The initial value of the calculation target number M is assumed to be N that is the total number of the storage locations for memory data of the storage device 17. Therefore, the calculation target number M is maintained at “M=N” unless the step S156 is executed. After the step S156, the processing proceeds to the step S111.

In the flowchart in FIG. 28 of the present embodiment, the step S204 of the flowchart in FIG. 15 of the third embodiment is replaced with a step S254, and the step S205 of the flowchart in FIG. 15 is replaced with a step S255. In the flowchart in FIG. 28, a step S257 is added to the flowchart in FIG. 15, and the step S257 is provided as the next step after the step S227.

In the step S254, an average value calculation part 18 calculates the average value μpmdav of the provisional maximum friction values μpmd from the following formula F9 on the basis of the provisional maximum friction values μpmd stored in the storage device 17. In the subsequent step S255, a standard deviation calculation part 19 calculates the standard deviation σpmd of the provisional maximum friction values μpmd from the following formula F10 on the basis of the provisional maximum friction values μpmd stored in the storage device 17 and the average value μpmdav calculated from the following formula F9. After the step S255 in FIG. 28, the processing proceeds to a step S206.

$$μ pmdav = \frac{1}{M} {\sum }_{i = 1}^{M} μ pmd \qquad ( F9 )$$

$$σ pmd = \sqrt{\frac{1}{M} {\sum }_{i = 1}^{M} {( μ pmd - μ pmdav )}^{2}} \qquad ( F10 )$$

Here, the above formula F9 is obtained by replacing N, which is the constant in the above formula F1, with the calculation target number M, and is the same as the above formula F1 except for this point. In addition, the above formula F10 is obtained by replacing N, which is the constant in the above formula F2, with the calculation target number M, and is the same as the above formula F2 except for this point. Note that, in a case where the calculation target number M is “M≤0”, the above formulas F9 and F10 cannot be calculated, and thus, for example, in the steps S254 and S255, the average value μpmdav and the standard deviation σpmd are not updated and are held as the previous values.

Therefore, if the calculation target number M remains at N that is the initial value, the average value μpmdav and the standard deviation σpmd are calculated, also in the present embodiment as in the third embodiment, based on the memory data D₁ to D_{N} that are all of the provisional maximum friction values μpmd stored in the storage device 17, as illustrated in FIG. 6. In short, in the step S254 in this case, the average value μpmdav of the memory data D₁ to D_{N} is calculated from the above formula F9, and in the step S255, the standard deviation σpmd of the memory data D₁ to D_{N} is calculated from the above formula F10.

On the other hand, in a case where the calculation target number M is “M<N” in the step S156 in FIG. 27, the average value μpmdav and the standard deviation σpmd are calculated based on, among all of the memory data D₁ to D_{N} stored in the storage device 17, the memory data D₁ to D_{M} on the newer side in time series. Then, among the memory data D₁ to D_{N}, the memory data D_{M+1} to D_{N} on the older side in time series are not used for calculating the average value μpmdav and the standard deviation σpmd. In short, in the step S254 in this case, the average value μpmdav of the memory data D₁ to D_{M} is calculated from the above formula F9, and in the step S255, the standard deviation σpmd of the memory data D₁ to D_{M} is calculated from the above formula F10.

In the step S257 following the step S227 in FIG. 28, the road surface determination part 24 sets the calculation target number M to “M=N”. In short, the road surface determination part 24 returns the calculation target number M to N that is the initial value. When the step S257 ends, the subroutine in FIG. 28 ends and the processing returns to the flowchart in FIG. 27.

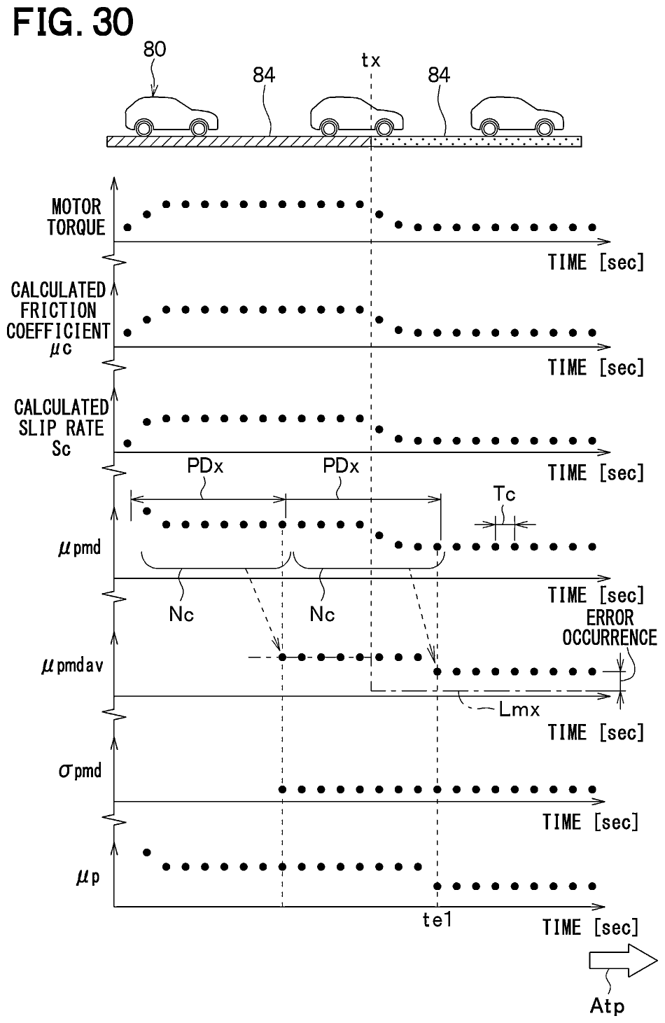

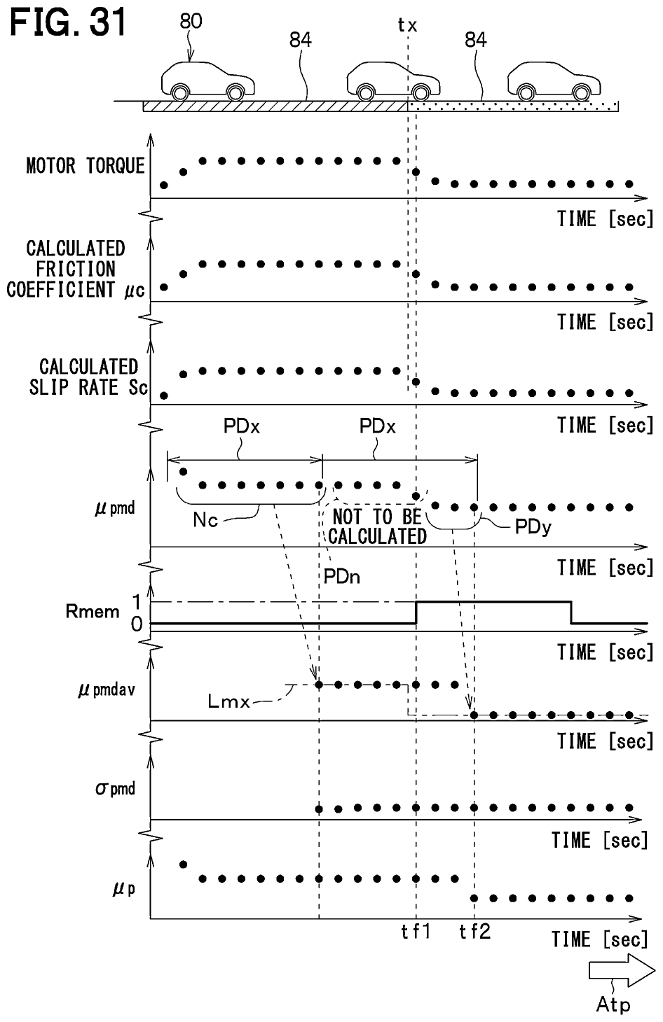

Next, in order to describe the effects of the present embodiment, control processing in the above-described comparative example, in which the determination range Rj is determined without taking into consideration the switching of the road surface 84 on which the vehicle is traveling, will be described with reference to time charts in FIG. 30. This comparative example is similar to the present embodiment except that the determination range Rj is determined without determining whether the switching of the road surface 84 has occurred. Note that, in the example in FIG. 30 and the example in FIG. 31 to be described later, N, which is the total number of the storage locations in the storage device 17, is “N=8”.

In the comparative example, the average value μpmdav of the provisional maximum friction values μpmd is calculated at a time point te1 on the basis of the provisional maximum friction values μpmd that have been calculated within the accumulation period PDx straddling the time point tx, which is a time point when the road surface 84 is switched, and that are accumulated in the storage device 17, as illustrated in FIG. 30. That is, the average value μpmdav adopted at the time point te1 is calculated based on the provisional maximum friction value μpmd obtained before the time point tx and the provisional maximum friction value μpmd obtained after the time point tx. Therefore, the deviation between the average value μpmdav and the maximum value μmx of the actual friction coefficient μ on the road surface 84 on which the vehicle is traveling increases due to the switching of the road surface 84, and the deviation state continues until the average value μpmdav is updated next time. Note that the transition of the maximum value μmx of the actual friction coefficient μ is indicated by a dash-dot line Lmx in FIG. 30.

Subsequently, the control processing of the present embodiment, that is, the control processing in FIGS. 27 and 28 will be described with reference to time charts in FIG. 31. As illustrated in FIGS. 31 and 28, the determination range Rj of the provisional maximum friction value μpmd of the present embodiment is repeatedly determined based on the average value μpmdav and the standard deviation σpmd obtained from the provisional maximum friction values μpmd calculated within the accumulation period PDx as the predetermined period. As a result, the determination range Rj is sequentially updated. The same is also true for the comparative example and for the above-described third embodiment. Note that the provisional maximum friction values μpmd calculated within the accumulation period PDx correspond to the memory data D₁ to D_{N} in FIG. 6 and may be referred to as multiple within-period provisional values for short.

The road surface friction estimation device 10 of the present embodiment includes a road surface determination part 24 that determines whether a state change in the road surface 84 on which the vehicle is traveling has occurred, unlike the comparative example. Therefore, in the present embodiment, the flag variable Rmem is switched from “Rmem=0” to “Rmem=1” at a time point tf1 immediately after the time point tx that is a time point when the road surface 84 is switched, as illustrated in FIG. 31. As a result, it is determined in the step S155 in FIG. 27 that the state change in the road surface 84, on which the vehicle is traveling, has occurred.

As a result of the determination, the calculation target number M is determined according to the above formula F8 in the step S156 in FIG. 27. Specifically, at the time point tf1 in FIG. 31, the number Nyt of remaining storage locations learned in the step S156 is “Nyt=4”, and thus the calculation target number M is determined as “M=4−1=3” from the above formula F8. The calculation result of “M=3” is maintained until the calculation target number M is thereafter set to “M=N” in the step S257 in FIG. 28.

Therefore, the average value μpmdav of the provisional maximum friction values μpmd calculated at a time point tf2 in FIG. 31 is calculated according to the above formula F9 in the step S254 in FIG. 28 in which the calculation target number M is assumed as “M=3” as described above. Then, the standard deviation σpmd of the provisional maximum friction values μpmd calculated at the time point tf2 is calculated according to the above formula F10 in the step S255 in FIG. 28 in which the calculation target number M is assumed as “M=3”.

That is, the average value μpmdav and the standard deviation σpmd are calculated based on the memory data D₁ to D₃ that are three provisional maximum friction values μpmd on the newer side in time series stored in the storage device 17 in FIG. 6. In FIG. 31, the memory data D₁ to D₃ correspond to the three provisional maximum friction values μpmd calculated within the adoption period PDy of the accumulation period PDx straddling the time point tx in FIG. 31. The memory data D₄ to D₈, which are five provisional maximum friction values μpmd on the older side in time series stored in the storage device 17, are not used for calculating the average value μpmdav and the standard deviation σpmd at the time point tf2. In FIG. 31, the memory data D₄ to D₈ correspond to the five provisional maximum friction values μpmd calculated within the exclusion period PDn of the accumulation period PDx straddling the time point tx in FIG. 31. The five provisional maximum friction values μpmd within the exclusion period PDn include the provisional maximum friction value μpmd obtained before the time point tx when the state change in the road surface 84 occurs.

At the time point tf2, the determination range Rj of the provisional maximum friction value μpmd is determined based on the average value μpmdav and the standard deviation σpmd obtained from the three provisional maximum friction values μpmd calculated within the adoption period PDy.

When it is determined within a certain accumulation period PDx that the state change in the road surface 84 has occurred, the average value μpmdav and the standard deviation σpmd are calculated based on the provisional maximum friction values μpmd within the adoption period PDy obtained by excluding the five provisional maximum friction values μpmd within the exclusion period PDn from the multiple within-period provisional values, as described above. Then, the determination range Rj of the provisional maximum friction value μpmd is determined based on the average value μpmdav and the standard deviation σpmd obtained from the provisional maximum friction values μpmd within the adoption period PDy.

Therefore, compared to the comparative example, the deviation of the average value μpmdav of the provisional maximum friction values μpmd from the maximum value μmx of the actual friction coefficients μ indicated by the dash-dot line Lmx in FIG. 31 can be more suppressed in the present embodiment. That is, compared to the comparative example, an inappropriate determination range Rj of the provisional maximum friction value μpmd, due to the switching of the road surface 84, can be more suppressed from being temporarily set. Note that, in the example in FIG. 31, the calculation number of the provisional maximum friction values μpmd within the adoption period PDy is 3, but may be 1 depending on the size of the calculation target number M.

The present embodiment is similar to the third embodiment except for what have been described above. In the present embodiment, effects, that are to be exerted by the configuration common to the above-described third embodiment, can be obtained similarly to the third embodiment.

Although the present embodiment is a modification based on the third embodiment, the present embodiment can also be combined with any one of the second, fourth, and fifth embodiments described above.

### OTHER EMBODIMENTS

(1) In each of the embodiments, the vehicle 80, on which the road surface friction estimation device 10 in FIG. 1 is mounted, is, for example, an electric vehicle that does not include an engine and uses a traveling motor as a driving power source, but this is an example. The vehicle 80 may be a hybrid vehicle or an engine vehicle that does not include a traveling motor.
(2) In each of the embodiments, the road surface friction estimation device 10 calculates the estimated maximum friction value μp for each wheel of the tires 81 that are driving wheels, but this is an example. For example, the road surface friction estimation device 10 may calculate the estimated maximum friction value μp for a combination of all the wheels of the tires 81 or a combination of a pair of the left and right tires 81.
(3) In each of the embodiments, the slip rate Sc is calculated based on the vehicle body speed, the driving wheel speed, the steering angle, the yaw rate of the vehicle 80, and the acceleration of the vehicle 80 as illustrated, for example, in FIG. 2, but this is an example. The physical quantities, which are the basis for the calculation of the calculated slip rate Sc, are not limited thereto, and may be appropriately selected. The same is also true for the physical quantities that are the basis for the calculation of the calculated friction coefficient μc. The physical quantities, that are the basis for the calculation of the calculated friction coefficient μc, are not limited to those illustrated in FIG. 2, and may be appropriately selected.

In addition, the method of calculating the provisional maximum friction value μpmd is not limited to the method disclosed in the first embodiment, and the provisional maximum friction value μpmd may be calculated without using the friction coefficient map MPm in FIG. 5. For example, a tire model formula may be set in advance by computer simulation, so that the provisional maximum friction value μpmd may be calculated according to the tire model formula. Furthermore, the slip rate S or the friction coefficient μ may not be used to calculate the provisional maximum friction value μpmd, and the provisional maximum friction value μpmd may be calculated based on other parameters.
(4) In each of the embodiments, the determination range Rj of the provisional maximum friction value μpmd is set to a range of “μpmdav±3·σpmd” as illustrated, for example, in FIG. 4, but this is an example. The determination range Rj may be, for example, a range of “μpmdav±σpmd” or a range of “μpmdav±2·σpmd”.
(5) In the sixth embodiment, the calculation target number M is calculated from the above formula F8 in the step S156 in FIG. 27, but this is an example. The calculation target number M may be set, for example, to “M=Nyt”.
(6) In the sixth embodiment, the determination as to whether the state change in the road surface 84 has occurred is made using the difference of “dμc/dSc” as illustrated in FIG. 27, but this is an example. For example, the determination may be made based on, for example, an image captured by an in-vehicle camera that photographs the road surface 84, without using the difference of “dμc/dSc”.
(7) In each of the embodiments, the road surface friction estimation device 10 is described as one independent device as illustrated, for example, in FIG. 2, but may be a control unit included in an in-vehicle electronic control device as a functional part of the electronic control device.
(8) Note that the present disclosure is not limited to the above-described embodiments, and various modifications can be made. In addition, the above embodiments are not unrelated to each other, and can be appropriately combined unless the combination is obviously impossible.

In addition, in each of the embodiments, it goes without saying that the elements constituting the embodiment are not necessarily essential except for a case where it is explicitly stated that the elements are particularly essential and a case where the elements are considered to be obviously essential in principle. In each of the above embodiments, when a numerical value, such as the number, numerical value, amount, or range of the components of the embodiment, is referred to, the numerical value is not limited to a specific number unless otherwise specified as essential or obviously limited to the specific number in principle. In each of the above embodiments, when the material, shape, positional relationship, or the like of the constituent elements or the like is referred to, the material, shape, positional relationship, or the like is not limited to a specific material, shape, positional relationship, or the like unless otherwise specified or limited thereto in principle.

The control unit and the method thereof described in the present disclosure may be realized by a dedicated computer provided by configuring a processor and a memory programmed to execute one or more functions embodied by a computer program. Alternatively, the control unit and the method thereof described in the present disclosure may be realized by a dedicated computer provided by configuring a processor with one or more dedicated hardware logic circuits. Alternatively, the control unit and the method thereof described in the present disclosure may be realized by one or more dedicated computers configured by a combination of a processor and a memory, programmed to execute one or more functions, and a processor configured with one or more hardware logic circuits. In addition, the computer program may be stored in a computer-readable non-transition tangible recording medium as an instruction to be executed by a computer. Note that the control unit corresponds to the road surface friction estimation device 10 of each embodiment.

What is claimed is:

1. A road surface friction estimation device that estimates a maximum value of a friction coefficient between a road surface on which a vehicle travels and a tire of the vehicle as an estimated maximum friction value, the road surface friction estimation device comprising:
a first estimation part configured to calculate a provisional maximum friction value that is a provisional value of the estimated maximum friction value based on a physical quantity detected during traveling of the vehicle in relation to friction between the road surface and the tire;
a range determination part configured to determine, based on an average value and a standard deviation of the provisional maximum friction values calculated by the first estimation part, a determination range of the provisional maximum friction value including the average value; and
a second estimation part configured to determine the provisional maximum friction value as the estimated maximum friction value when the provisional maximum friction value is within the determination range, and determine a corrected value, which is a value within the determination range, as the estimated maximum friction value when the provisional maximum friction value is out of the determination range.

2. The road surface friction estimation device according to claim 1, wherein
the second estimation part repeatedly determines the estimated maximum friction value as time passes, and
the corrected value is a previous value of the estimated maximum friction value.

3. The road surface friction estimation device according to claim 1, wherein the corrected value is the average value.

4. A road surface friction estimation device that estimates a maximum value of a friction coefficient between a road surface on which a vehicle travels and a tire of the vehicle as an estimated maximum friction value, the road surface friction estimation device comprising:
a first estimation part configured to calculate a provisional maximum friction value that is a provisional value of the estimated maximum friction value based on a physical quantity detected during traveling of the vehicle in relation to friction between the road surface and the tire;
a range determination part configured to determine, based on an average value and a standard deviation of the provisional maximum friction values calculated by the first estimation part, a determination range of the provisional maximum friction value including the average value; and
a second estimation part configured to determine the provisional maximum friction value as the estimated maximum friction value when the provisional maximum friction value is within the determination range, and determine a median of the provisional maximum friction values as the estimated maximum friction value when the provisional maximum friction value is out of the determination range.

5. The road surface friction estimation device according to claim 1, wherein
the range determination part determines the determination range based on the average value and the standard deviation obtained from the provisional maximum friction values calculated within a predetermined period every time the provisional maximum friction value is calculated, and
the predetermined period shifts to a side on which time passes every time the provisional maximum friction value is calculated.

6. The road surface friction estimation device according to claim 1, wherein
the range determination part:
includes a data storage part that stores the provisional maximum friction value every time the first estimation part calculates the provisional maximum friction value; and
determines, based on the average value and the standard deviation obtained from the provisional maximum friction values stored in the data storage part, the determination range every time a predetermined calculation number of the provisional maximum friction values are stored in the data storage part.

7. The road surface friction estimation device according to claim 1, comprising a road surface determination part configured to determine whether a state change in the road surface, in which a state of the friction between the road surface and the tire changes beyond a predetermined limit, has occurred, wherein
the range determination part repeatedly determines the determination range based on the average value and the standard deviation obtained from within-period provisional values that are the provisional maximum friction values calculated within a predetermined period that shifts to a side, on which time passes, as time passes, and
when the road surface determination part determines that the state change in the road surface has occurred, the range determination part determines the determination range based on the average value and the standard deviation obtained from one or more provisional maximum friction values obtained by excluding the provisional maximum friction value obtained before the state change in the road surface occurs from the within-period provisional values.

8. The road surface friction estimation device according to claim 1, wherein the first estimation part calculates the friction coefficient and a slip rate of the tire based on the physical quantity, and calculates the provisional maximum friction value based on the friction coefficient and the slip rate.

9. A road surface friction estimation device configured to estimate a maximum value of a friction coefficient between a road surface on which a vehicle travels and a tire of the vehicle as an estimated maximum friction value, the road surface friction estimation device comprising:
a processor and a memory configured to
calculate a provisional maximum friction value that is a provisional value of the estimated maximum friction value based on a physical quantity detected during traveling of the vehicle in relation to friction between the road surface and the tire;
determine, based on an average value and a standard deviation of the provisional maximum friction values calculated by the first estimation part, a determination range of the provisional maximum friction value including the average value; and
determine the provisional maximum friction value as the estimated maximum friction value when the provisional maximum friction value is within the determination range, and determine a corrected value, which is a value within the determination range, as the estimated maximum friction value when the provisional maximum friction value is out of the determination range.
